(19) United States
(12) Patent Application Publication
(10) Pub. No.: US 2002/0090596 A1
(43) Pub. Date: Jul. 11, 2002

(54) Apparatus, systems and methods for electronically teaching phonics

(76) Inventors: John R. Sosoka, Long Beach, CA (US); Mark D. Schwartz, Santa Monics, CA (US); Richard A. Suchter, Arcadia, CA (US); Douglas A. Kerns, Sierra Madre, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/780,674

(22) Filed: Feb. 9, 2001

Related U.S. Application Data
(60) Provisional application No. 60/181,378, filed on Feb. 9, 2000.

(51) Int. Cl. G09B 1/00

(52) U.S. Cl. 434/167

(57) ABSTRACT

The present invention provides apparatus, systems and methods for electronically teaching phonics. The exemplary embodiment provides a base unit with multiple receiving wells for blocks. The outer surface of each face of each block expresses an alphabetic character. Each face of each alphabet block has a unique bit pattern expressed in a pattern of electrically conductive material that identifies the alphabetic character expressed on the outer surface of the opposing block face. Underneath the exposed surface of the floor of each block receiving well, is an electronic sensing device. The electronic sensing device uses capacitive coupling in accordance with a test bit pattern to identify the alphabetic character expressed by each block in each block receiving well. A computer device, such as a microprocessor, identifies phonetic relationships between the exposed letters and determines the phoneme for each exposed alphabetic character for each block in a block receiving well. The invention then audibly plays the phoneme representing each exposed alphabetic character according to a player's instructions.

### CROSS-REFERENCE TO RELATED APPLICATIONS

This application claims the benefit of U.S. Provisional Application No. 60/181,378 filed Feb. 9, 2000, which is hereby incorporated by reference as if set forth in full herein.

### FIELD OF THE INVENTION

The present invention relates generally to educational toys and specifically to educational toys for teaching phonics.

### BACKGROUND OF THE INVENTION

The word “phonics” means a method of teaching beginners to read, spell and pronounce new words by learning the sounds of letters and letter groups. For each language, such as the English language, there have been numerous publications of sets of various rules by which the sounds of letters and letter groups can be described. However, the published sets of rules are complex, and in written form, are not well suited for teaching beginning speakers and readers of a language, such as very young children, to read, spell, or pronounce new words. Further, self-exploration of a new subject has been shown to be an effective way of learning. However, in the past, there has not been an effective way of providing beginners with a way of self-teaching phonics. Therefore, a way is needed to help beginners, such as very young children, learn to read, spell and pronounce new words.

### SUMMARY OF THE INVENTION

The present invention provides apparatus, systems and methods for electronically teaching phonics. The exemplary embodiment provides a base unit with multiple receiving wells for blocks. The outer surface of each face of each block expresses an alphabetic character. Each face of each alphabet block has a unique bit pattern expressed in a pattern of electrically conductive material that identifies the alphabetic character expressed on the outer surface of the opposing block face. Underneath the exposed surface of the floor of each block receiving well, is an electronic sensing device. The electronic sensing device uses capacitive coupling in accordance with a test bit pattern to identify the alphabetic character expressed by each block in each block receiving well. A computer device, such as a microprocessor, identifies phonetic relationships between the exposed letters and determines the phoneme for each exposed alphabetic character for each block in a block receiving well. The invention then audibly plays the phoneme representing each exposed alphabetic character according to a player's instructions.

The present invention provides apparatus, systems and methods for electronically teaching phonics that utilizes an individual's natural curiosity and willingness to explore to help beginning speakers and readers, such as very young children, develop their own sound heuristics. The exemplary embodiment of the invention described here is a toy that facilitates self-teaching of phonics in the English language for very young children. The exemplary toy is illustrative and is not a limitation of the invention. It should be understood by someone with ordinary skill in the art that the invention applies equally to more sophisticated models that provide more complex word and word combination building, and for languages other than English.

The present invention provides a base unit, also referred to as the “console”. The base unit has a top, a bottom, a front orientation, and a back orientation. In the top of the base unit, there are five receiving block wells (also referred to as “block stations”) for lettered blocks. Four Mode buttons and a Play button are provided on the top of the base unit.

The four Mode buttons are used to select the mode of play: “Song”, “Explore”, “Spelling”, or “Activity”. The toy provides the child playing (the “player”) with feedback, the type of feedback varying according to the mode in which the player has chosen to operate the toy. In Song mode, children can play with blocks and music, and become familiar with the sound that each letter makes. In Explore mode, children can play with letters and the sounds they make by pressing the blocks in the block stations. In Spelling mode, children can practice spelling and sounding out words. In Activity mode, children can practice finding letters in directed play.

Each block station displays a lighting feature such that when a block is placed into the well, the lighting feature, if on, is evident from the front orientation of the base unit.

As with the traditional alphabet blocks of yesterday, each block for the present invention has six faces; each face of each block has a letter. For example, one block features the letters “A” on two faces, “B” on two faces, and “C” on the remaining two faces. Each letter is capitalized and underlined, the underline indicates the correct orientation of the letter for placement in the well. On some block faces, instead of the letter, a picture for which the word describing the picture begins with the letter featured on that particular face of the block. For instance, a block face that features the letter “C” can display a picture of a Cat.

As opposed to traditional solid wooden blocks of yesterday, the blocks provided by the present invention provide an electronic sensing device pattern on the inside of each block face. The sensing pattern identifies the letter on the face opposite the face inside which the sensing pattern exists. The floor of each block station provides a sensing device such that, when a block is pressed into the block station, the sensing device in the floor of the block station identifies the letter, which is displayed on the top face of the block exposed in the block station.

The present invention provides a computer device, such as a microprocessor, which determines, among other things, the mode in which the toy is operating, the identity of each alphabetic character for all blocks resting in block stations, and relationships between the identified alphabetic characters.

The terms microprocessor and microcontroller are used interchangeably herein. The description of a microprocessor as the particular computer device by which the functions and processes described herein are performed is illustrative and not a limitation of the invention. Someone with ordinary skill in the art will understand that the invention applies equally, without departing from the spirit of the invention, to other computer devices, including for instance, a modem connection to a server computer over a global communications network such as the Internet.

The toy operates in multiple modes, depending upon the choice of the player. If the toy is operating in, for example, the Explore mode, the computer device applies phonics rules to deduce the sound of each letter according to its proximity to, and context with, other alphabetic characters (“letters”) in the other block stations. Using voice circuitry, the computer device plays the sound for each letter, or if the letters spell a word, the computer device plays the sound of the word. As the computer device plays the sound for each letter, the computer devices uses electrical circuitry to light the lighting feature around the top surface of that block station.

### DESCRIPTION OF THE DRAWINGS

FIG. 1 is a graphic representation depicting a front view of an exemplary embodiment of the base unit of the present invention;

FIG. 2 is a graphic representation depicting a back view of an exemplary embodiment of the base unit of the present invention;

FIG. 3a is a graphic representations depicting a cut-away side view of an exemplary block station;

FIGS. 3b-3c are graphic representations depicting a cut-away side view of an exemplary block in an exemplary block station;

FIGS. 4a-4e are graphic representations depicting exemplary configurations of blocks in an exemplary embodiment of the base unit of the invention;

FIG. 5 is a graphic representation depicting an exemplary configuration of blocks in an exemplary embodiment of the base unit of the invention;

FIG. 6 is graphic representation depicting a table of phonemes;

FIG. 7a is a graphic representation depicting an exemplary embodiment of a binary template;

FIGS. 7b-7c are graphic representations depicting the overlay of an exemplary embodiment of a binary template over block stations in the base unit of the invention;

FIGS. 8a-8d are a graphic representation of a portion of an exemplary embodiment of a dictionary of words and instructions;

FIG. 9 is graphic representation depicting the contents of an exemplary embodiment of the binary template overlaying block stations in an exemplary embodiment of the base unit of the invention;

FIG. 10 is a graphic representation depicting a six-faced block;

FIGS. 11a-11m are logic flow diagrams depicting the phonics rules logic for an exemplary embodiment of the invention;

FIG. 12 is a block diagram depicting one embodiment of the present invention;

FIG. 13 is a block diagram depicting the hardware architecture of one embodiment of the present invention;

FIG. 14 is a process diagram depicting generation of a phoneme sequence within one embodiment of the present invention; and

FIG. 15 is a process diagram depicting generation of a single phoneme within one embodiment of the present invention.

### DETAILED DESCRIPTION OF THE INVENTION

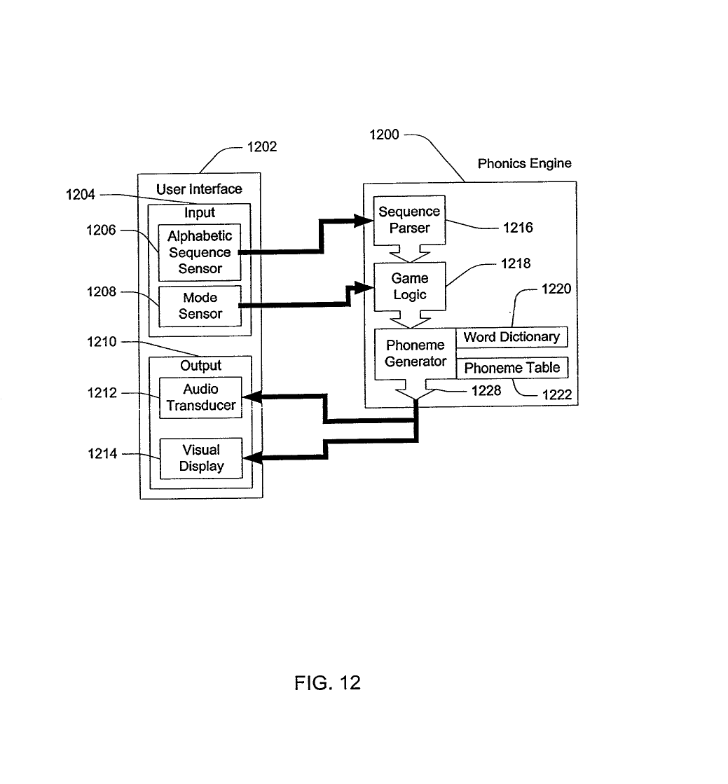

FIG. 12 is a block diagram depicting one embodiment of the present invention. The invention comprises phonics engine 1200 for generation of phonemes in response to inputs received from a user interface 1202. A player uses the user interface to select a mode of play and to input an alphabetic sequence of alphabetic characters. The phonics engine responds by outputting a phoneme sequence consisting of one or more phonemes that is presented to the player through an audio transducer. A visual display information is also generated for presentation to the player.

The user interface is comprised of an input portion 1204 and an output portion 1210. The input portion is comprised of a alphabetic sequence sensor 1206 for sensing an alphabetic sequence and a mode sensor 1208 such as a multi-position switch for setting a playing mode. The output portion is comprised of an audio transducer 1212 for presentation of the phoneme sequence such as an audio speaker. The output portion further comprises a visual display 1214 for presentation of visual display information related to the phoneme sequence.

In operation, the player uses the alphabetic sequence sensor to arrange an alphabetic sequence such as a string of letters. The player sets the mode switch to invoke various play modes and the phonics engine responds by outputting a phoneme sequence through the audio transducer. The player also receives a visual display depicting the relationships between the phonemes in the phoneme sequence and the alphabetic sequence.

The phonics engine is comprised of a sequence parser 1216 operably coupled to the alphabetic sequence sensor and game logic 1218. The sequence parser receives the alphabetic sequence from the alphabetic sequence sensor and creates an internal representation of the alphabetic sequence for further processing by the phonics engine. The game logic is also operably coupled to the mode sensor. The game logic reads the mode sensor and accepts the alphabetic sequence and determines what kind of phoneme sequence is to be generated.

A phoneme generator 1228 is operably coupled to a word dictionary 1220 and a phoneme table 1222. The word dictionary contains a set of alphabetic sequences associated with phoneme keys and visual display generation instructions. The phoneme keys are indexes into the phoneme table where individual phonemes are stored. The phoneme generator searches the word dictionary to find a match for an input alphabetic sequence. If a match is found, the phoneme generator reads the phoneme keys and generates a phoneme sequence from the phoneme keys and phoneme table. If there is no match in the word dictionary for the alphabetic sequence, then the phoneme generator generates a phoneme sequence using a set of phonics rules. The phoneme sequence is output to the audio transducer for presentation to the player.

The phoneme generator also generates visual display information based on visual display generation instructions associated with the words stored in the word dictionary or based on the phonics rules. The visual display information is presented to the player using the visual display.

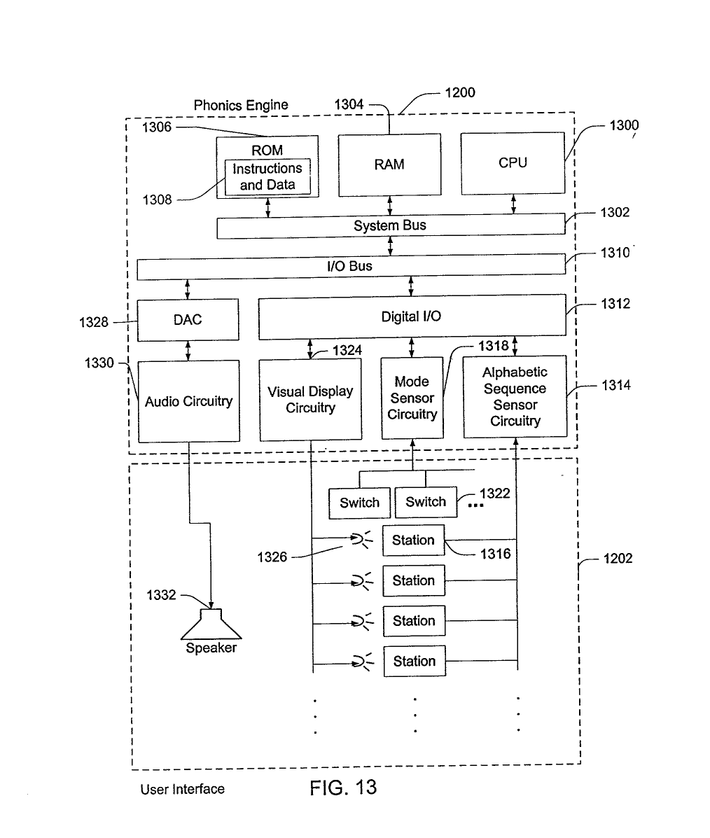

FIG. 13 is a hardware architecture diagram for one embodiment of the present invention. The phonics engine 1200 is implemented using a microprocessor based controller with Input/Output (I/O) capabilities for both analog and digital signals. The controller is augmented with audio circuitry 1330, visual display circuitry 1324, mode sensor circuitry 1318, and alphabetic sequence sensor circuitry 1314 for interfacing the phonics engine to components comprising the user interface 1202.

A CPU 1300 is operably coupled to Random Access Memory 1304 (RAM) and Read Only Memory (ROM) by system bus 1302. In operation, the CPU uses programming instructions 1308 stored in the ROM to implement the logic of the phonics engine. The previously described word dictionary and phoneme table are stored on the ROM as well. The RAM is used by the CPU to store game playing difficulty levels between player interaction sessions. The RAM is also used by the CPU for temporary data storage during generation of the previously described phoneme sequence and visual display information.

The CPU is operably coupled through the system bus and an Input/Output (I/O) bus 1310 to a Digital to Analog Converter 1328 (DAC) and a digital I/O interface 1312. The DAC is further operably coupled to audio circuitry 1330. The controller uses the DAC to create audio signals for digitally encoded phonemes stored in the phoneme table.

The digital I/O interface is operably coupled to visual display circuitry 1324, mode sensor circuitry 1318, and alphabetic sequence sensor circuitry 1314.

The controller uses the digital I/O interface and visual display circuitry to send visual information signals to the user interface.

The controller uses the mode sensor circuitry to sense the state of mode setting switches in the user interface.

The controller uses the digital I/O interface and alphabetic sequence sensor circuitry to sense an alphabetic sequence entered by a player using the user interface.

The user interface 1202 comprises an audio speaker 1332 operably coupled to the audio circuitry for presentation of phonemes generated by the phonics engine to the player, a visual display composed of a plurality of lighting features 1326 operably coupled to the visual display circuitry for presentation of visual phoneme sequence information, a plurality of game mode setting switches 1322 operably coupled to the mode sensor circuitry for setting game modalities, and a plurality of stations 1316 operably coupled to the alphabetic sequence sensor circuitry for sensing individual elements of an alphabetic sequence composed by a player.

In operation, a player arranges physical objects representing the individual elements of an alphabetic sequence such that the physical objects are sensed by the plurality of stations. The player sets the game mode switches to select a particular mode of play. The phonics engine reads the mode switches and alphabetic sequence to create a phoneme sequence. The phoneme sequence is presented to the player using the audio speaker. Additionally, a visual display is created by the phonics engine and presented to the player using the plurality of lighting features.

Base Unit

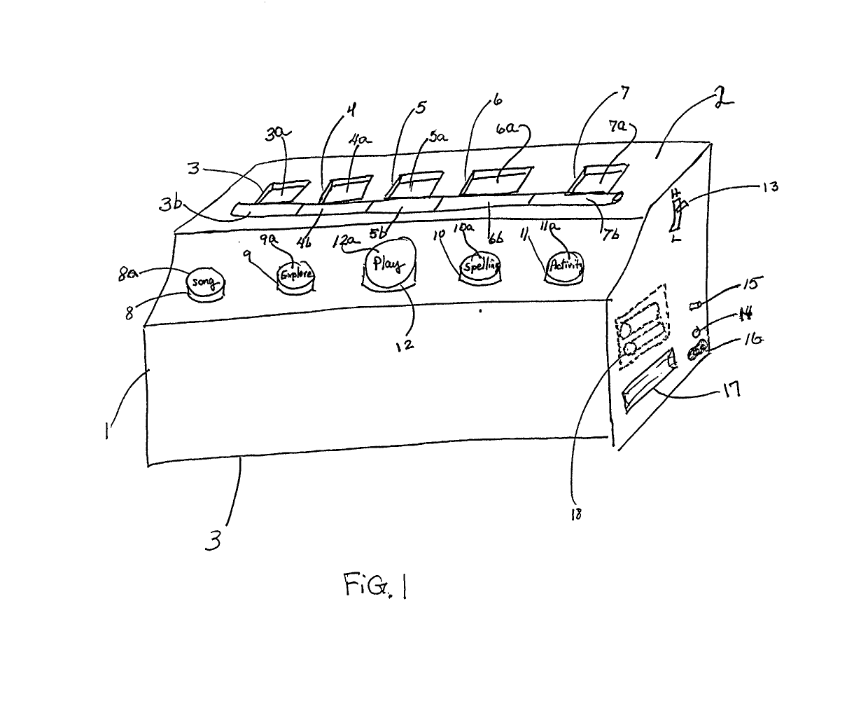

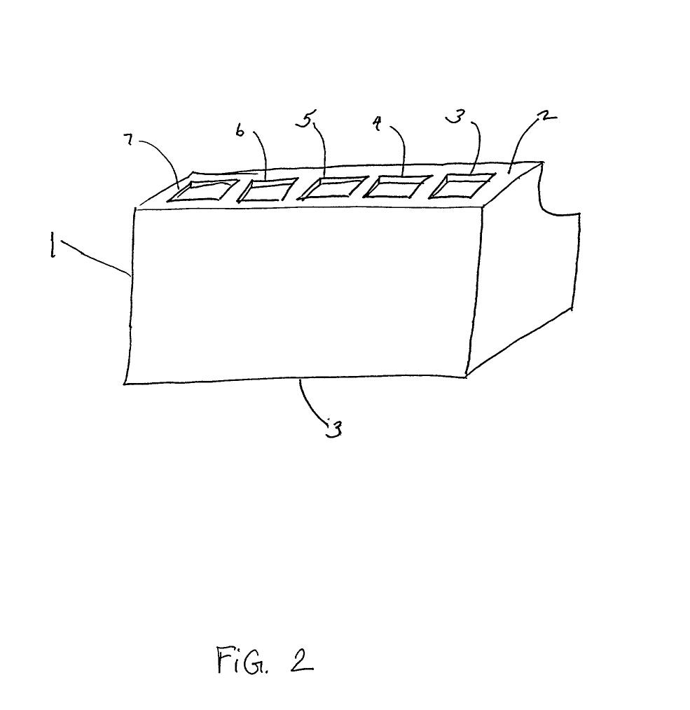

An exemplary embodiment of the present invention described herein, as depicted in FIG. 1, has a base unit 1, also referred to as a “console” 1. The base unit 1 has a top 2, a front orientation as depicted in FIG. 1, a back orientation as depicted in FIG. 2, and a bottom 3. As is also depicted in FIG. 1, in the top 2 of the base unit 1, there are five receiving block wells 3-7 (also referred to as “block stations”) for receiving lettered objects such as blocks or tiles. The presence of a lettered block or tile in a receiving well is used to determine one element of an alphabetic sequence. The the number of wells depicted in the exemplary embodiment is illustrative and not a limitation of the invention.

The base unit 1 further provides four Mode buttons 8-11 and a Play button 12 on the top 2 of the base unit 1. Each of the four Mode buttons 8-11 and the Play button 12 has a lighting feature 8a-12a respectively, such as an LED.

The base unit further provides a High/Low volume switch 13, a headphone jack 14, a Reset button 15, an AC adapter port 16, Cyber Cartridge receptacle 17 and is battery powered 18.

Block Station

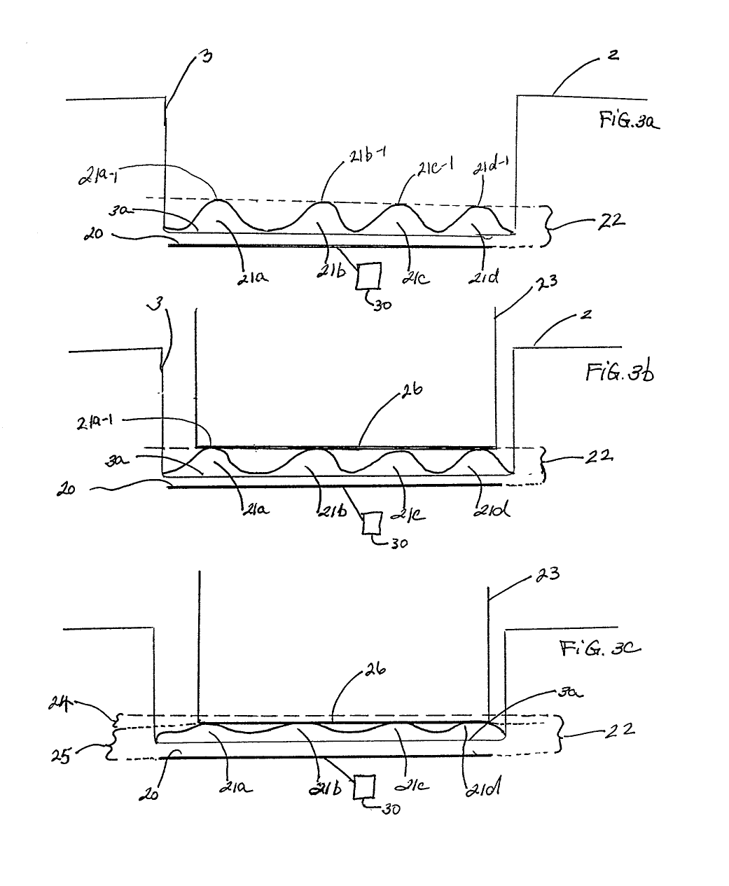

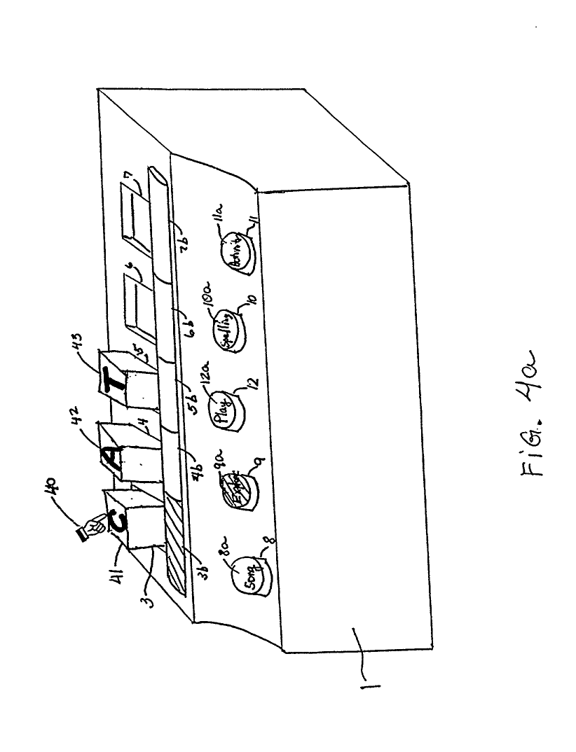

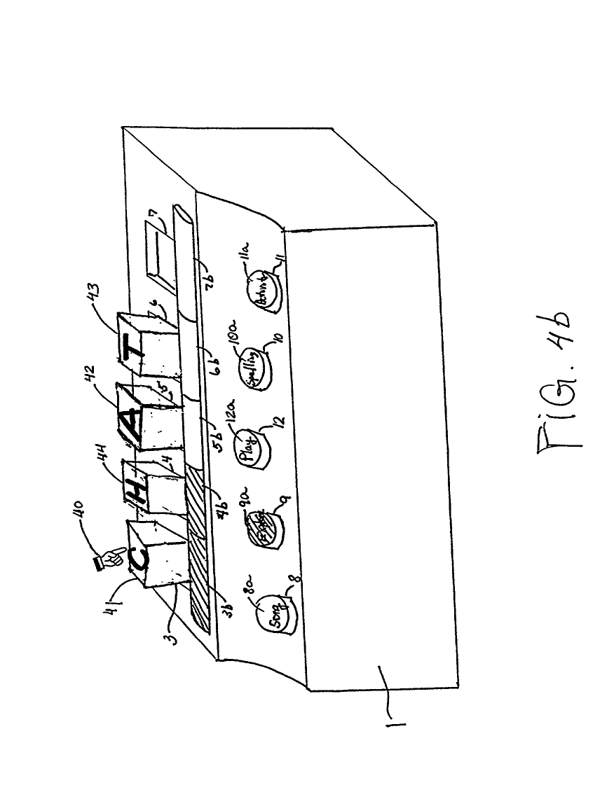

Each block station 3-7 has a floor 3a-7a. The floor 3a-7a of each block station 3-7 has a surface which is described further below, underneath of each of which is provided an electronic sensing device 20 as depicted in FIGS. 3a-3c, each of which is provided with its own set of analog and digital electronics as described below and as disclosed in detail in copending U.S. Utility Patent Application attorney docket number 37539/FLC/N240, the disclosure of which is incorporated here by reference as if fully stated here for all purposes. In the exemplary embodiment depicted herein, a single computer device, e.g., a microprocessor, is shared by the multiple block stations 3-7.

As depicted in FIG. 3a, the surface of each block station floor 3a-7a in the exemplary embodiment features numerous tiny projections, e.g., 21a-21d, referred to here as “knuckles”, that project upward from the block station floor 3a-7a. When the knuckles are at rest, the highest point of the upper surface of each knuckle, e.g., 21a-1, is a certain distance 22 (referred to herein as the “at-rest distance”) from the surface of the floor, e.g., 3a, of the block station, e.g., 3. As depicted in FIG. 3b, when a player places a block, e.g., 23, in a block station, e.g., 3, the knuckles, e.g., 21a-21d support the block at the at-rest distance 22 from the block station floor, e.g., 3a. When the block merely rests on top of the knuckles as depicted in FIG. 3b, the microprocessor 30 for the sensing device 20 underneath the surface of the blocking station floor 3a senses the identification of the block and the at-rest distance 22 of the block from the sensing device 20 from the electrically conductive sensing pattern 26 inside the bottom surface of the block 23. From that information, the microprocessor 30 for the sensing device 20 deduces that the block is merely at rest. The toy responds to the at-rest position of the block 23 in the block station 3 according to the requirement of the mode in which the toy is being operated at the time.

The knuckles, e.g., 21a-21d, provide levitation of the block that rests on the knuckles. In alternative embodiments, other mechanisms are used to levitate a block at an at-rest distance from the block station floor surface, such as, for example, foam rubber.

As depicted in FIG. 3c, as opposed to an at-rest position in which the block 23 rests at an rest distance 22 from the sensing device 20, the player can press a block, e.g., 23, into a block station, e.g., 3. Pressing the block 23 into the block station 3, compresses the knuckles, e.g., 21a-21d, by a compression distance 24, so that the distance 25 between the sensing device 20 is smaller than the at-rest distance 22. The compression distance 24 is a variable that depends upon the amount of pressure with which the block 23 is pressed into the block station, e.g., 3. Accordingly, the distance 25 is a variable that can be calculated as the difference between the at-rest distance 22 and the compression distance 24. Alternatively, the compression distance can be calculated as the difference between the at-rest distance 22 and the distance 25 as measured by the microprocessor 30. The microprocessor 30 detects the smaller distance 25 as compared to the at-rest distance 22 between the electrically conductive sensing pattern 26 inside the bottom surface of the block 23. From the distance calculated by the microprocessor 30, the microprocessor 30 deduces that the block is pressed into the block station, as opposed to being merely at rest. The toy will then respond to the pressed position of the block in the block station according to the requirement of the mode in which the toy is being operated at the time.

Each block station 3-7 has a lighting feature 3b-7b. The microprocessor 30 is connected to each of the lighting feature 3b-7b The lighting feature is used as a feedback mechanism for the player.

Blocks

The exemplary Phonics toy embodiment provides a plurality of interchangeable blocks, an example of which is depicted in FIG. 3. In the exemplary embodiment of the Phonics toy described here, sixteen alphabet blocks are provided in four different colors. All letters displayed on the blocks are in upper case. The blocks are color-coded into four sections of the alphabet: A-F are blue; G-L are green; M-R are orange; S-Z are red.

Different block layouts are provided. One block layout provides three different letters, each letter appearing on the block on two different faces. Some letters are represented as pictures, for example, a picture of an apple is displayed instead of the letter A. A second block layout provides six (6) different letters. Each block face provides a visual cue, such as underlining, to indicate the bottom orientation of the letter displayed on the face of the block that is visible from a top front orientation of the base unit 1.

In the exemplary embodiment of the Phonics toy depicted here, block layouts are as follows: 1) AABBCC (blue); 2) DDEEFF (blue); 3) ABCDEF (blue) 4) ABCDEF (blue); 5) GGHHII (green); 6) JJKKLL (green); 7) GHIJKL (green); 8) GHIJKL (green); 9) MMNNOO (orange); 10) PPQQPP (orange); 11) MNOPQR (orange); 12) MNOPQR (orange); 13) SSTTUU (red); 14) UUVVWW (red); 15 XXYYZZ (red); 16) STUVWS (red). The block layouts described above are exemplary and not a limitation of the invention.

In one embodiment of the present invention, the blocks are replaced by a plurality of tiles. Each tile has a top surface and a bottom surface. The top surface of each tile has a letter displayed on it. The bottom surface of each tile mates with a block station.

Modes of Play

When the toy is turned on, the toy plays a “Hello” sequence, and lights all lighting features 3b-7b for each block station 3-7 for a short time, such as 0.5 seconds. The toy then sequentially lights all lighting features 3b-7b for each block station 3-7 for a short time, such as 0.25 seconds, for a total start sequence time, of, for example, 1.25 seconds. The toy then begins to operate in a default mode, for example, the Song mode.

At any time while the toy is turned on, the player pressing one of the four Mode buttons will cause the lighting feature for that Mode button to light, the microprocessor announces that Mode, and the toy begins to operate in that Mode. If the base unit 1 of the toy is left inactive for 120 seconds, the microprocessor announces “Goodbye” and goes into a sleep Mode.

Song Mode

As mentioned above, Song Mode is the default Mode of operation for the toy. If the player turns on the base unit 1, or if the player presses the Song Mode button, the toy will announce the Song Mode and will play an introductory musical phrase that prompts the player to put a block in a block station to play the game. As an example, the toy plays “Put a block in. Press on the block . . . ”.

If the player does not respond within a certain time, for example 30 seconds, then the toy repeats the prompt. If the player does not respond within a certain time, for example 30 seconds, after the second prompt, the toy says “Goodbye” and goes into Sleep Mode.

The Song Mode operates in two submodes. In the first submode, the player must press a block into a blocking station to cause the toy to respond. In this first submode, once the player places a block, e.g., 23 as depicted in FIG. 3b, in a block station, e.g., 3 and presses the block 23 into the block station 3 as depicted in FIG. 3c, the toy plays a musical sequence that is based on a musical template that has been mapped to letter or picture depicted on the exposed block face. In an exemplary embodiment, a first musical template is mapped to block face letters A-F (green blocks); a second musical template is mapped to block face letters G-L (blue blocks); a third musical template is mapped to block face letters M-R (red blocks); and a fourth musical template is mapped to block face letters S-Z (orange blocks). The musical template mapping described above is provided for illustrative purposes and is not a limitation of the invention. In other embodiments, a separate musical template is mapped to each letter and to each picture.

A musical template is a set of predefined words and variables set to music. A default phoneme, a sound, for each letter is mapped to each letter. For example, the letter “C” can be represented by several different phonemes, depending upon the context of the letter with respect to other letters. For purposes of the Song Mode, a default phoneme for the letter “C”, such as the /k/ sound in the word “cat”, is mapped to the letter “C”.

The microprocessor 30 creates a musical sequence by merging the Song Mode phoneme mapped to the letter on the exposed face of the block with the musical template mapped to that letter. For example, a musical template for the letter “B” is:/*/ /*/ “That's a sound I like to say” /*/ /*/. The “/*/” symbols represent a position for the playing of the phoneme for a letter. When a player presses a block with the letter “B” exposed on the top face into a well, e.g., 3, the toy identifies the letter as the letter “B” using the sensing technology described below, identifies the musical template mapped to that letter, identifies the phoneme mapped to that letter, merges the phoneme mapped to the letter “B” with the musical template mapped to the letter “B” and plays the following musical sequence: “/b/ /b/ That's a sound I like to say /b/ /b/”.

In a second submode, the player presses the Play button 12, as depicted in FIG. 1. After the player has pressed the Play button 12, the toy successively plays the musical sequence according to the musical template and phoneme mapped to the letter depicted on the top surface face of each block that has been placed in a block station. After sequentially playing the musical sequences for each block, the toy plays a musical loop. If the player presses a button or a block, the toy stops playing the musical loop.

If the player presses on a block during any sequence or loop, the sequence or loop is interrupted and the toy plays the sound for the exposed block face.

If the player presses the Play button 12, such as is depicted in FIG. 1, during any sequence, the toy begins playing the sequence again; if there is more than one block in the block stations 3-7, the toy plays the musical sequences, starting with the musical sequence for the block in the first block station beginning with block station 3; if there is only one block in a block station, then the toy plays the musical sequence for letter on the exposed face of that block.

If the player does not press a button or a block for a certain period of time, or for a certain number of times in which the musical loop is played, the toy announces “Goodbye” and goes into Sleep mode.

Explore Mode

In Explore Mode, the player can play with letters and combinations of letters to explore the sounds they make. To begin the Explore Mode, the player presses the Explore Mode button 9. The toy responds by lighting the Explore Mode button lighting feature 9a, announcing the Explore Mode, and loading, or otherwise accessing, phonics rules and the phonics engine, both of which are described in detail below.

If after thirty (30) seconds after entering the Explore Mode, the player has not put a block into a block station, the toy plays a prompt, e.g., “Put a block in and press it.” If after thirty (30) seconds of inactivity, the player has put in a block, but has not pressed the Play button 12 or the block, the toy plays a prompt, e.g., “Press a block to get started.” After an additional thirty (30) seconds of inactivity, the toy repeats the prompt that it last played. After 120 seconds of inactivity, the toy plays the word “Goodbye” and goes into Sleep mode.

In Explore Mode, the microprocessor 30 for the sensing device 20, as depicted, e.g., in FIG. 3a, determines, in a way that is described in detail as part of the Sensing Device section of this disclosure, the identity of each block that is placed in each well. If the player replaces one or more blocks in one or more block stations with a different block, the microprocessor 30 for the sensing device 20 identifies each new block. Even though the microprocessor 30 identifies each block in each block station 3-7, in Explore Mode, the toy does not play sounds unless the player presses a block or presses the Play button 12.

If the player presses a block, the toy uses the phonics engine and phonics rules to determine the correct sound for the pressed letter. Reference herein to a pressed block, pressed block letter, or pressed letter refer to the letter that is displayed on the top exposed surface of a block in a block station. The toy, using the phonics engine and phonics rules, determines the sound of each pressed block letter in context with any other blocks that have been placed in any other block stations 3-7.

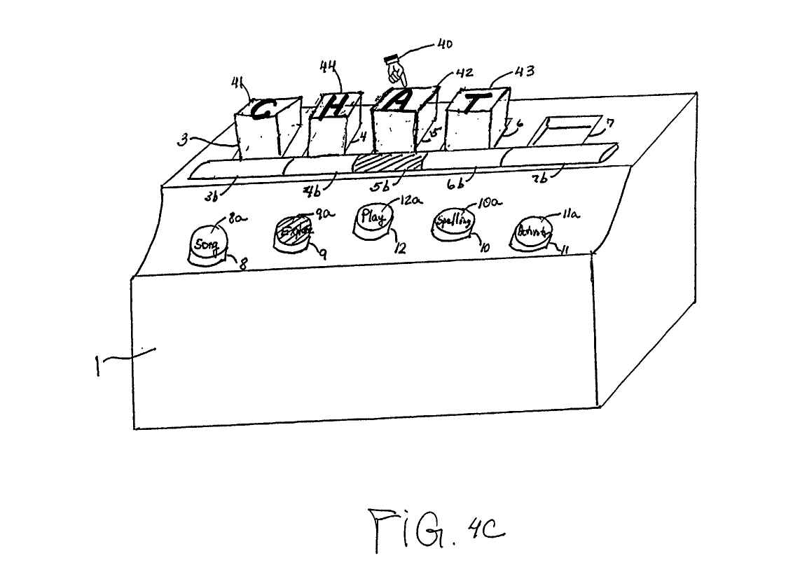

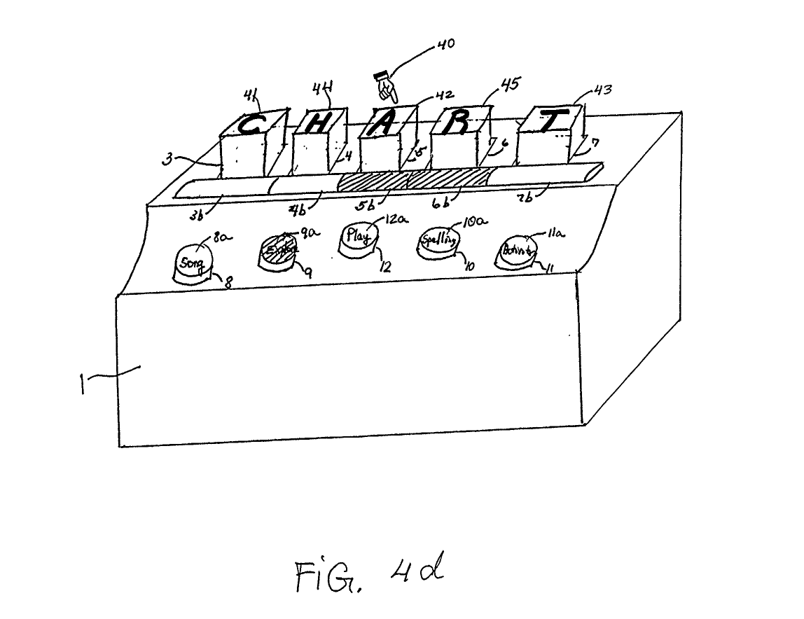

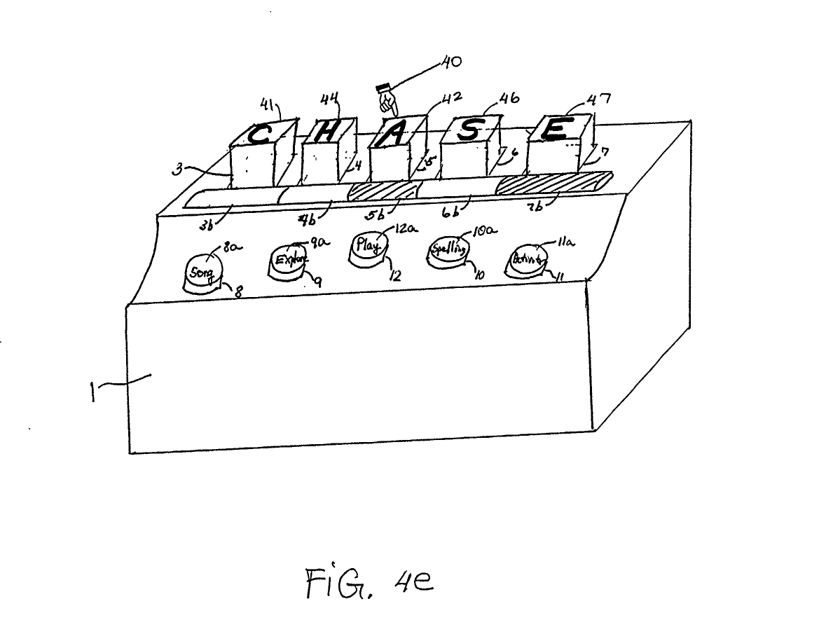

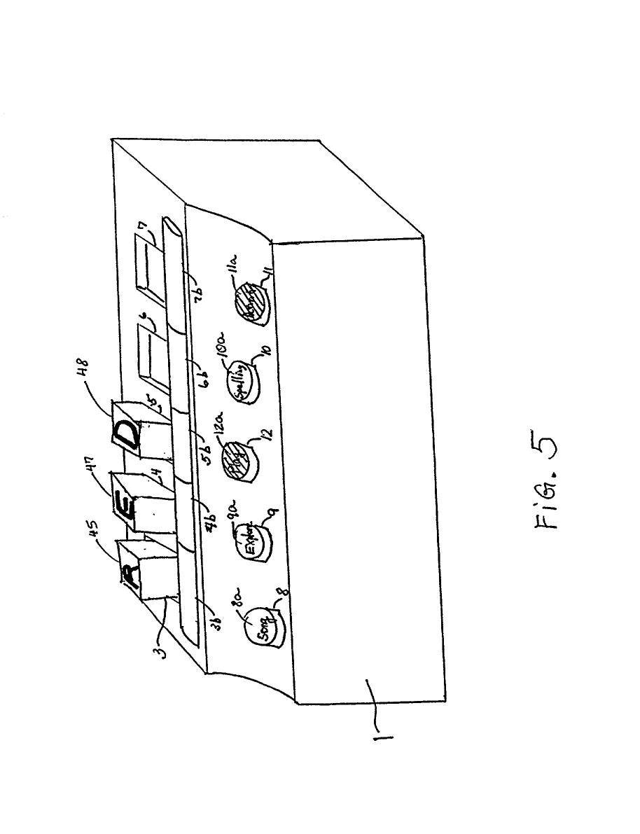

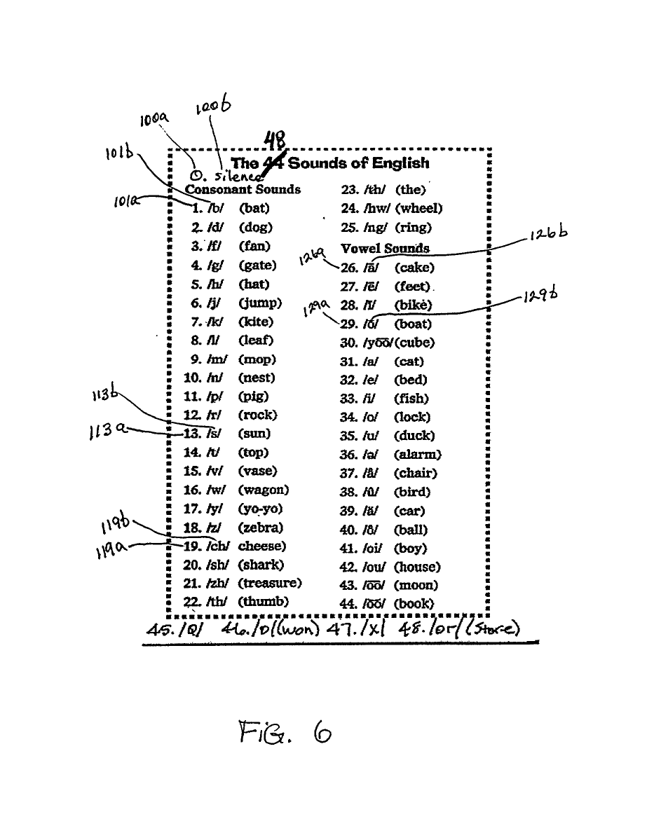

If, on the other hand, the pressed block is the only block in a block station, or if the pressed block letter is not affected by any other placed block, the toy recognizes the context, plays the correct sound of the sound for the pressed block letter, and lights the lighting feature associated with the block station in which the pressed block letter rests. This situation is illustrated in an example as depicted in FIG. 4a. Note that in the FIGURES, diagonal marking of a light feature, e.g., 3b-7b, 8a-12a, indicates that the light feature is lighted.

As depicted in FIG. 4a, there are three blocks: a “C” block 41, an “A” block 42, and a “T” block 43 in block stations 3-5 respectively; block stations 6-7 are empty. The microprocessor 30 (not shown in FIG. 4a) for sensing device 20 (not shown in FIG. 4a) determines the identity of each of the three blocks. As is depicted in FIG. 4a, with the toy in Explore mode 9, the Explore mode light feature 9a is lighted. The player 40 presses the “C” block 41 into block station 3. The microprocessor 30, using the phonics engine and phonics rules, determines that, and plays the sound /k/ for, the letter “C” as in the word “Cat”, and lights the light feature 3b for the block station in which the pressed letter is pressed, in this case, 3.

If the blocks 41, 42 and 43 are in block stations 3-5 as depicted in FIG. 4a, and if the player presses the Play button 12, the Play button light feature 12a is lighted and the microprocessor forms a “word” the three block letters (“C”, “A”, and “T”) attempts to look for the “word” in a dictionary table/database. The dictionary table/database is described in the phonics engine section of this disclosure. The microprocessor finds the word “Cat” in the dictionary/database, the toy plays the word “Cat” and lights up all of the light features 3b-5b for the block stations 3-5 in which the blocks 41, 42 and 43 rest.

If, when the player presses the Play button 12 while the toy is in Explore mode, the microprocessor 30 does not find the word in the dictionary, the toy plays the sound (phoneme) for each letter or letter group separately and consecutively, such as when a human sounds out a word. As it plays each phoneme, the toy lights the light feature for the block station(s) for which it is playing a phoneme, including adjacent letters that form what is known as a “digraph” (a digraph is a group of two successive letters that have a single sound, such as the “CH” in the word “chart”).

If the sound of the pressed block letter is affected by any other placed blocks, the toy recognizes the context, plays the correct sound for the pressed block letter, and lights the lighting feature associated with the block station in which the pressed block letter rests and the lighting feature(s) associated with the block station(s) in which a block letter has been placed that affects the pressed block letter. This situation is illustrated in FIGS. 4b-4e.

In FIG. 4b, there are four blocks: a “C” block 41, an “H” block 44, an “A” block 42, and a “T” block 43 in block stations 3-6 respectively; block station 7 is empty. The microprocessor 30 (not shown in FIG. 4b) for sensing device 20 (not shown in FIG. 4b) determines the identity of each of the four blocks. As is depicted in FIG. 4b, with the toy in Explore mode 9, the Explore mode light feature 9a is lighted. The player 40 presses the “C” block 41 into block station 3. The microprocessor 30, using the phonics engine and phonics rules, determines that, and plays the sound /ch/ for, the letter “C” as in the word “Chat”, and lights the light feature 3b for the block station in which the pressed letter is pressed, in this case, 3, and lights the light feature 4b for the block station 4 in which the “H” block 44 rests.

As depicted in FIG. 4c, the player 40 then presses the “A” block 42 in block station 5. The system then plays the /a/ sound as in the word “chat” and lights the light feature 5b for the block station 5 in which the “A” block 42 is pressed.

The player then replaces the “T” block 43 with an “R” block 45 in block station 6, and places the “T” block 43 in block station 7 as depicted in FIG. 4d. The player 40 then presses the “A” block 42 in block station 5. The microprocessor 30 (not shown in FIG. 4d) for sensing device 20 (not shown in FIG. 4d) determines the identity of each of the five blocks (“C”, “H”, “A”, “R”, and “T”). As is depicted in FIG. 4d, with the toy in Explore mode 9, the Explore mode light feature 9a is lighted. The microprocessor 30, using the phonics engine and phonics rules, determines that, and plays the sound /a/ for the letter “A” as in the word “Chart”, and lights the light feature 5b for the block station in which the pressed letter is pressed, in this case, 5, and lights the light feature 6b for the block station 6 in which the “R” block 45 rests.

Next, as depicted in FIG. 4e, the player replaces the “R” block 45 with an “S” block 46 in block station 6, and replaces the “T” block 43 in block station 7 with an “E” block 47. The player 40 then presses the “A” block 42 in block station 5. The microprocessor 30 (not shown in FIG. 4e) for sensing device 20 (not shown in FIG. 4e) determines the identity of each of the five blocks (“C”, “H”, “A”, “S”, and “E”). As is depicted in FIG. 4e, with the toy in Explore mode 9, the Explore mode light feature 9a is lighted. The microprocessor 30, using the phonics engine and phonics rules, determines that, and plays, the sound /\overline{a}/ for the letter “A” as in the word “Chase”, and lights the light feature 5b for the block station in which the pressed letter is pressed, in this case, 5, and lights the light feature 7b for the block station 7 in which the “E” block 47 rests.

Spelling Mode

The player enters the Spelling Mode by pressing the Spelling Mode button 10. When pressed, the Spelling Mode button light feature 10a lights and the toy announces “Spelling”. The toy's microprocessor 30 loads the player's skill level, the word list for that level, and the phonics engine and phonics rules. If the player has not previously played the Spelling Mode, the toy's microprocessor 30 loads a beginner's skill level as the player's skill level. If the player has previously played the Spelling Mode, the toy's microprocessor 30 loads a previously determined skill level as the player's skill level.

The microprocessor picks words pseudo-randomly from the word list for the player's skill level. For each word selected, the toy selects one of various prompt templates, including, e.g.: “Spell”, “Let's spell”, “Please spell”, and “Now spell”. The microprocessor merges the selected word, e.g., “Bat” with the selected prompt template to form a prompt for the selected word. The toy then prompts the player to, e.g., “Spell Bat”.

If the toy remains inactive, such as when the player does not place any blocks in any block stations, or presses the Play button 12 without having placed any blocks in any block stations, then the toy prompts the player to “Put a block in.” and repeats the prompt, e.g., “Spell Bat”. After 120 seconds of inactivity, the toy plays the word “Goodbye” and goes into Sleep Mode.

If the player places the incorrect blocks in the block stations (for instance, “C”, “A” and “T” when the word to spell was “Bat”) and presses the Play button 12, the microprocessor 30 determines that the word spelled is incorrect. Then the microprocessor 30 determines, according to the phonics engine and the phonics rules, the phonemes for the letters played, and merges the phonemes with a template that plays “Oops, you spelled”. The toy then plays the merged message that says, e.g., “Oops, you spelled /c/ /a/ /t/.” The toy then merges the phonemes for the correct spelling of the word with the spell prompt, and plays the merged spell prompt, e.g., “Spell Bat, /b/ /a/ /t/”.

If the player is unable after three tries, each try being measured by the player pressing the Play button 12, then the toy ends the round by announcing “Let's spell a different word.” The toy then begins a new round by announcing “Let's try a different word. Spell” e.g., “Boy”.

In the Spelling Mode, if the player puts a block in a block station and presses the block, the toy plays the phoneme for the letter. If other blocks are in other block stations, the phoneme is determined in context with the other letters. If the pressed block letter is part of a digraph, the toy plays the phoneme for the digraph and lights the light features for both the pressed block and the other block station in which the remaining component of the digraph rests. If the pressed block letter is not part of a digraph, then the toy lights the light feature for the block station in which the block letter is pressed and plays the phoneme for the individual pressed block letter, in context with the other block letters in any other block stations.

If the player has correctly spelled the prompted word and presses the Play button 12, the toy randomly selects and plays a congratulatory reinforcement, such as: “Great”, “Super”, “That's right!”, “Yes!” in combination with a celebratory sound effect. The celebratory sound effect is created by the toy randomly selects and plays separate “wav” files, that typically each last between 0.1 and 0.5 seconds. With increases in the player's skill level, the number and length of sound effects increases.

If the player correctly spells seven (7) consecutive words from the player's current skill level, then the toy plays “You're a great speller!” and increments the player's skill level by one (1). The microprocessor 30 pulls words from the player's current skill level and all previous skill levels. A larger percentage of words are pulled from the current skill level. For example, for a player at level four, 80% of the words will be pulled from the level four list, 15% from level 3, 4% from level 2, and 1% from level 1.

If the player misspells fifteen (15) words from the player's current skill level, the player's skill level is decremented by one level and the count of misspelled words is reset to zero.

Activity Mode

If the player presses the Activity Mode button 11, the toy announces “Activity”. The toy's microprocessor 30 then loads the player's skill level, and the phonics engine and phonics rules. If the player has not previously played the Activity Mode, the toy's microprocessor 30 loads a beginner's skill level as the player's skill level. If the player has previously played the Activity Mode, the toy's microprocessor 30 loads a previously determined skill level as the player's skill level.

The toy then plays “Put a block in and press the play button.” If the player does not respond, of if the player presses the Play button 12 but places no blocks in the console, then after a period of thirty (30) seconds of inactivity, the toy repeats the prompt “Put a block in and press the Play button.” Once again, if the player does not respond, of if the player presses the Play button 12 but places no blocks in the console, then after a second period of thirty (30) seconds of inactivity, the toy repeats the prompt “Put a block in and press the Play button.” After 120 seconds of inactivity, the toy announces “Goodbye” and goes into Sleep Mode.

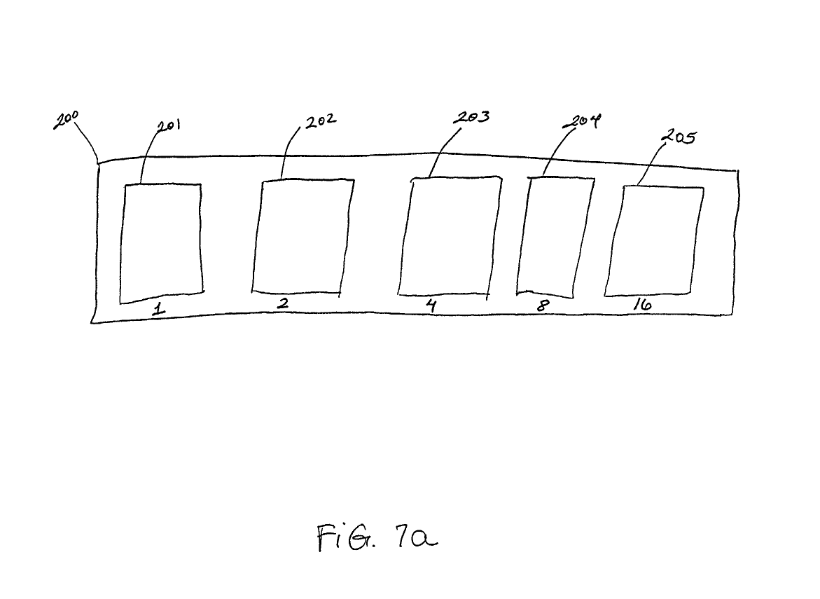

When the player presses the Play button 12 and there is at least one block in one of the block stations, the microprocessor 30 randomly selects the letter of one of the blocks in the block stations and prompts the player to press that letter, by announcing “Press the letter that makes the sound” and then plays the phoneme of the letter that has been selected. For example, as depicted in FIG. 5, in Activity Mode (the Activity Mode button 11 light feature 11a is lighted as depicted by the diagonal marking), the player has placed the “R” block 45 in block station 3, the “E” block 47 in block station 4, and the “D” block 48 in block station 5, and has pressed the Play button 12 (as depicted by the diagonal marking lighting the Play button light feature 12a). The microprocessor 30 using the sensing device 20 identifies each of the blocks as “R”, “E” and “D” respectively. The microprocessor 30 uses the phonics engine and phonics rules to determine the phoneme of each of the letters in context to the other letters present in the block stations. The microprocessor 30 then randomly selects one of the letters, which in the example is the letter “E”, and instructs the player to “Press the letter that makes the sound /e/”.

If the player skill level is level one, then the microprocessor 30 lights the light feature of the block station in which the selected letter rests as an additional prompt for the player.

If the player presses the incorrect letter, for example, the “R” block 45, the microprocessor 30 lights the light feature of the block station, in the example, block station light feature 3b, in which the player pressed the block and plays “You pressed” and plays the phoneme of the letter pressed /r/. The microprocessor then repeats the prompt, as in our example, to “Press the letter that makes the sound /e/”. If the player presses an incorrect letter three times, then the toy prompts the player to press a different letter.

If the player presses the correct letter, which in the example is the “E” block 47, the microprocessor 30 lights the light feature of the block station, which in the example is the light feature 4b, in which the block was correctly pressed and plays a congratulatory sequence that includes a statement, such as: “Great!”, “Super!”, “That's right!”, or “Yes”. The congratulatory sequence also includes celebratory sound effects. With each successive correct answer, the microprocessor 30 creates a shorter sound effect to increase the speed of the game.

If after pressing correct letters forty (40) times, the player has not moved any of the blocks, the toy prompts the player to rearrange the blocks by playing “Let's mix up the blocks and play some more.” If the player does not place any blocks in the base unit 1, after thirty (30) seconds of inactivity, the toy prompts the player to press “Put a block in and press the Play button.”

If the player presses the Play button 12 after the toy plays a phoneme, the toy repeats the phoneme. In the first skill level, the toy lights the light feature of the block station in which rests the block with the letter for which the phoneme was repeated.

After the player has pressed seven (7) correct letters in a row, the microprocessor 30 increments the skill level by one level. After the player has pressed three (3) incorrect letters in a row, the microprocessor 30 decrements the skill level by one level.

As the skill level advances, the prompts are reduced to playing the phonemes only, and the congratulatory sequences are shortened, eliminating the verbal phrases, and shortening the celebratory sound effects in order to accelerate the speed with which the player is expected to play the game.

Phonics Engine and Phonics Rules

Table of Sounds

Forty-eight (48) sounds, or phonemes, of English are provided in an exemplary embodiment of a phoneme table, a visual representation of which is depicted in FIG. 6. The phoneme table provides a number, e.g., 101a for each phoneme. The number is used as a key into the table. Associated with each number, e.g., 101a, is a phoneme, e.g., 101b. In FIG. 6, phonemes are represented by a standard phonetic visual representation, such as the case for the first entry in the table, “/b/” for the “b” sound in the word “bat”. The phoneme table, stored in the memory of the toy, does not contain the word “bat”. Rather, the table only provides the number key, e.g. 101a, and a digital representation of the sound, e.g., 101b.

Binary Template

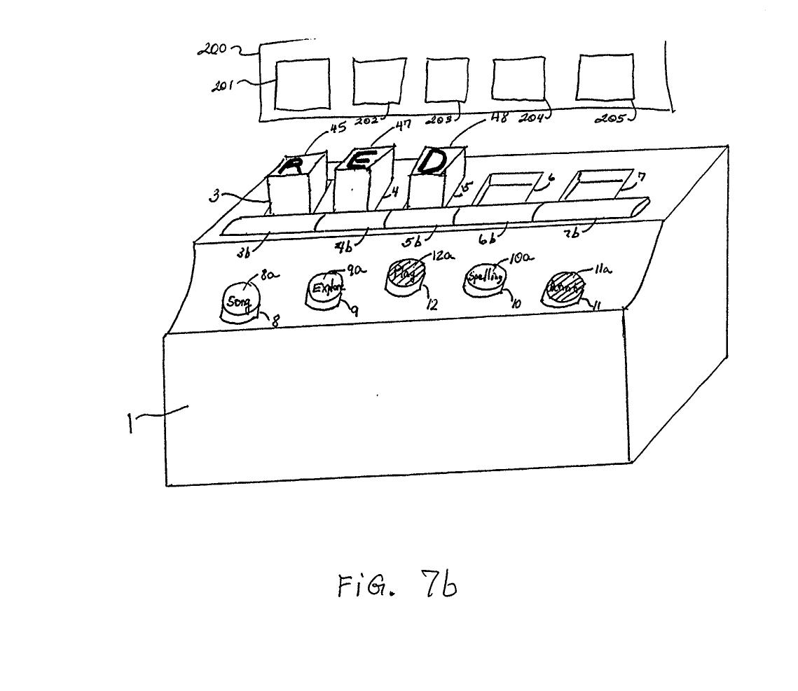

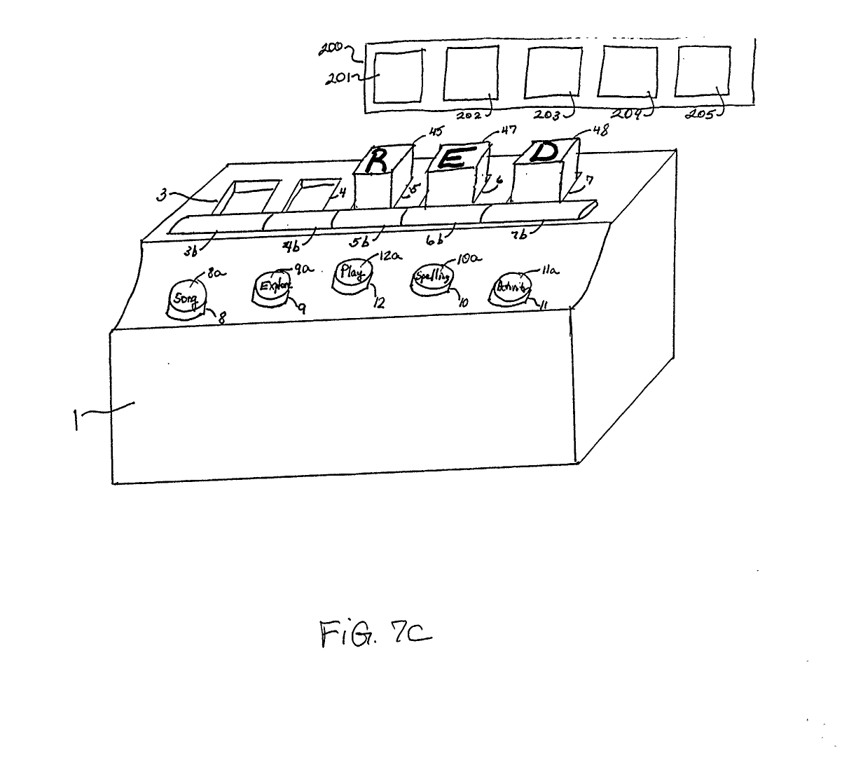

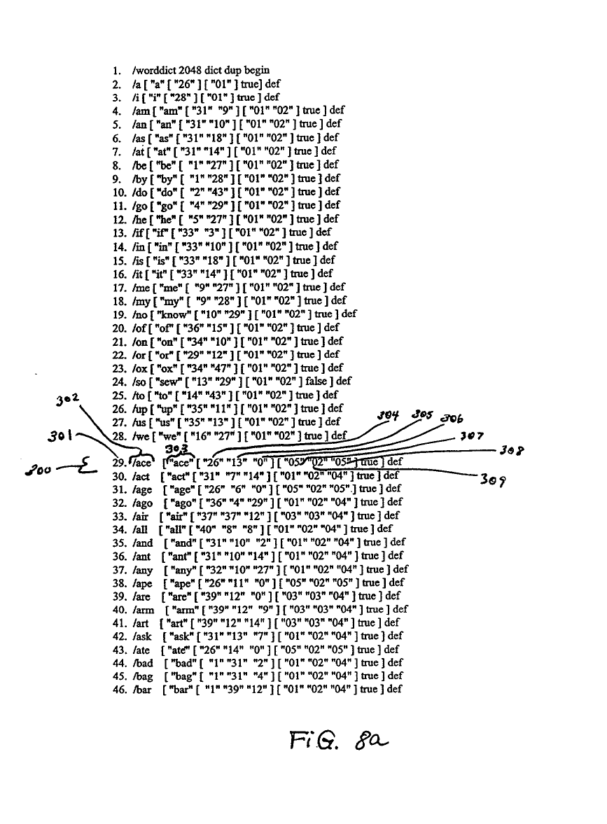

One aspect of the interface between the five block stations 3-7 and the phonics engine software executed by the microprocessor 30 is a five digit binary template 200 as depicted in FIG. 7a. FIG. 7a is a graphic representation conceptually depicting the five digit binary template 200. Someone with ordinary skill in the art will understand that the “template” 200 which is conceptually represented graphically in FIG. 7a is a five digit data field in memory. As depicted in FIG. 7a, the left-most digit 201 of the template 200 represents the value 1; the next digit 202 represents the value 2; the next digit 203 represents the value 4; the next digit 204 represents the value 8; and the right-most digit 205 represents the value 16.

The microprocessor 30 determines the first (left-most, beginning with block station 30) block station in which a block rests. The microprocessor 30 then overlays, the left-most block station in which a block rests with the first (left-most) digit 201 of the binary template 200. In the manner described below, the microprocessor 30 creates accessible relationships, such as in a cross-reference table, between: the left-most block station in which a block rests and the first (left-most) digit 201 of the binary template 200; and between each subsequent block station in which a block rests and the respective digit of the binary template 200. Examples are provided in FIGS. 7b and 7c and described below to illustrate the application of the binary template 200.

In FIG. 7b, an “R” block 45 rests in the left-most block station 3; an “E” block 47 rests in the next block station 4; and an “D” block 48 rests in the next block station 5. The microprocessor 30 identifies each block letter using the sensing device and identifies the block station in which each block letter rests as described in the preceding sentence. The microprocessor 30 then overlays the binary template 200 so that the left-most digit 201 of the binary template 200 is associated with block station 3, which is the first block station in which a block, the “R” block 45, rests. Having identified block station 3 as the first block over which to overlay the binary template 200, the microprocessor 30 overlays: the second binary digit 202 over block station 4; the third binary digit 203 over block station 5; the fourth binary digit 204 over block station 6; and the fifth binary digit 205 over block station 7. The microprocessor 30 thus creates a three-tiered relationship for the example depicted in FIG. 7b as follows:

| BLOCK STATION | LETTER | BINARY DIGIT |
|---|---|---|
| 3 | R | 201 |
| 4 | E | 202 |
| 5 | D | 203 |
| 6 | blank | 204 |
| 7 | blank | 205 |

In FIG. 7c, the “R” block 45 rests in the middle block station 5; the “E” block 47 rests in the next block station 6; and the “D” block 48 rests in the right-most block station 7. The microprocessor 30 identifies each block letter using the sensing device and identifies the block station in which each block letter rests as described in the preceding sentence. The microprocessor 30 then overlays the binary template 200 so that the left-most digit 201 of the binary template 200 is associated with block station 5, which is the first block station in which a block, the “R” block 47, rests. Having identified block station 5 as the first block over which to overlay the binary template 200, the microprocessor 30 then overlays: the second binary digit 202 over block station 6; and the third binary digit 203 over block station 7; the fourth binary digit 204 and the fifth binary digit 205 of the binary template 200 are not associated with any block station in this example. The microprocessor 30 thus creates a three-tiered relationship for the example depicted in FIG. 7c as follows:

| BLOCK STATION | LETTER | BINARY DIGIT |
|---|---|---|
| 3 | blank | not applicable |
| 4 | blank | not applicable |
| 5 | R | 201 |
| 6 | E | 202 |
| 7 | D | 203 |

The microprocessor 30 then uses the three-tiered accessible relationships described above between block stations in which lettered blocks rest 3-7, the corresponding letters, and the respective digits of the binary template 200 to manage the phonic interpretation of the phonemes of the letters present in the block stations 3-7, and the associated educational feedback to the player, such as the lighting of the appropriate block station light feature 3b-7b.

Dictionary of Words

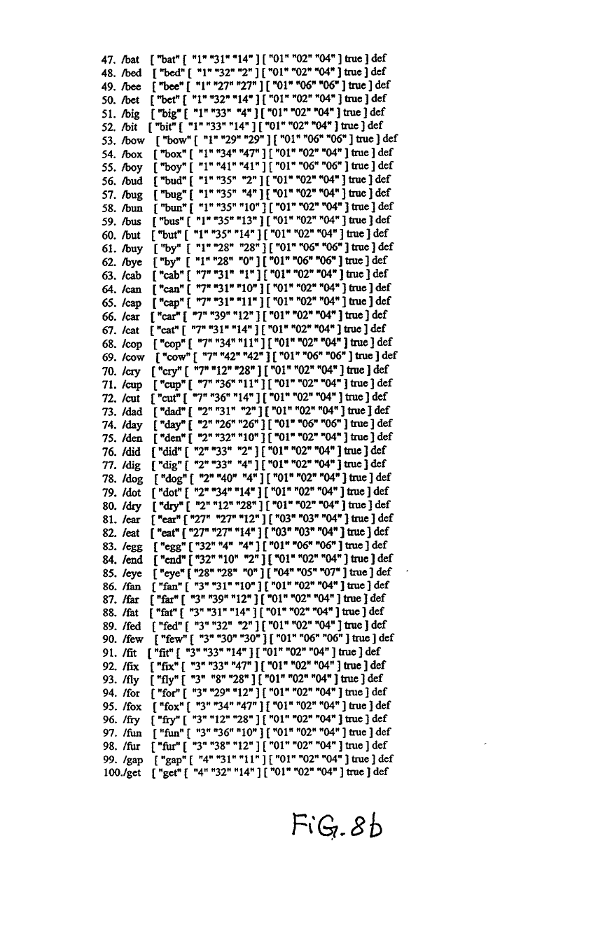

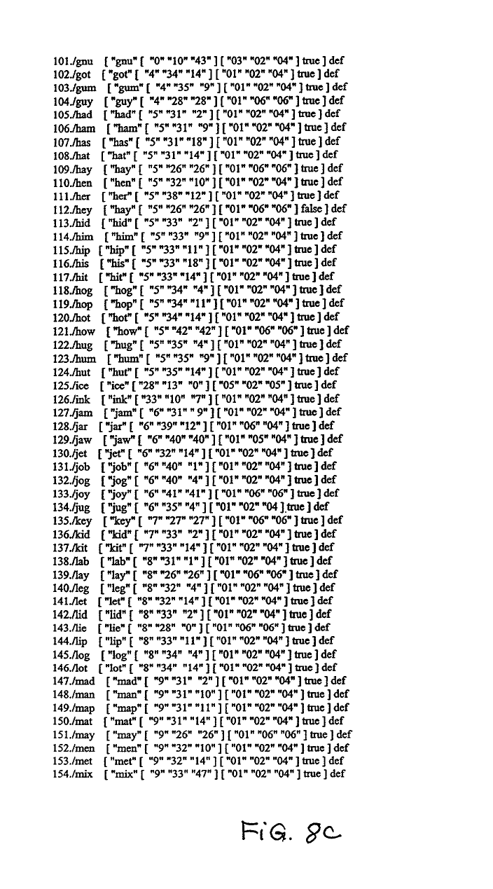

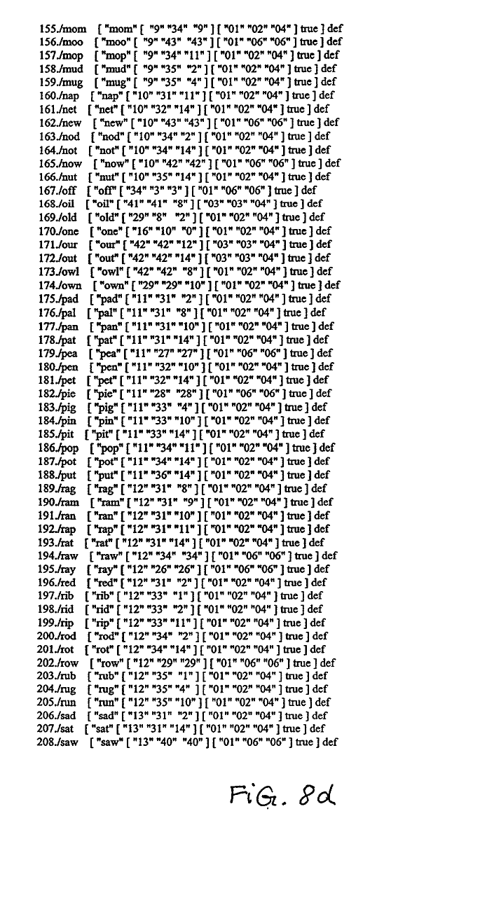

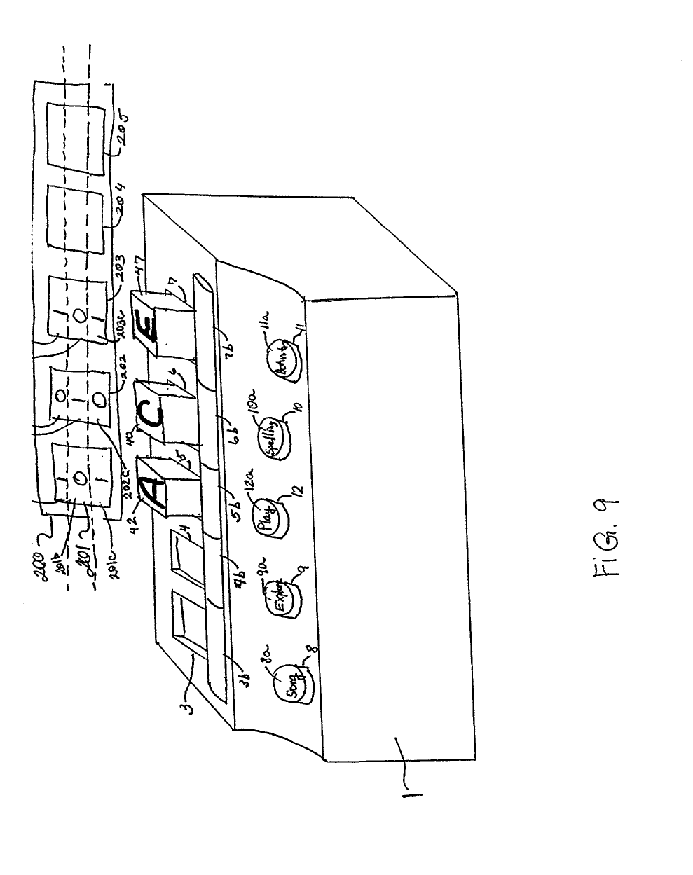

The microprocessor 30 uses the identified letters present in the identified block stations and the above-described three-tier accessible relationships with the binary digits of the binary template 200 to build an alphabetic sequence from which a word search key is created to search for a word in a word dictionary. A portion of an exemplary embodiment of a word dictionary is depicted in FIGS. 8a-8d.

As depicted in, e.g. FIG. 8a, and as explained in more detail below, the dictionary provides coded instructions, e.g. 303-309, for each single-, two-, three-, and four-letter word contained in the dictionary, e.g. 300. Each word entry, e.g., the entry for the word “ace” 300, in the dictionary contains, among other things, a number identifier key 301, which in the case of the entry for the word “ace” is 29; an alphabetic key 302 representing the letters of the word; a text representation of the word 303; a numeric key into the phoneme table for each letter in the word, e.g., 304-306; and instructions 307-309 for generating a visual display such as lighting the lighting features associated with the block stations in which the block letters forming the letters of the alphabetic sequence entry rest.

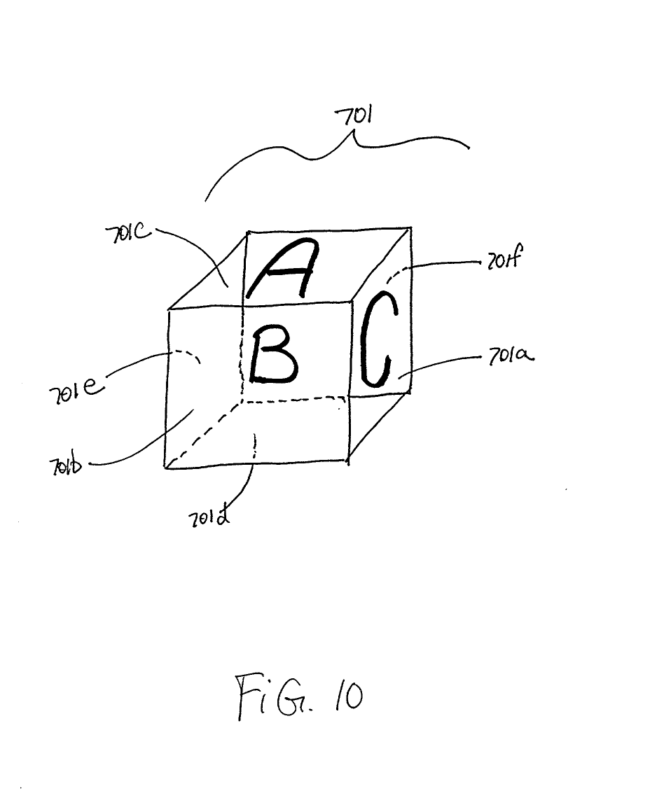

The example depicted in FIG. 9 is illustrative of an application of the dictionary. The microprocessor 30, using the sensing device 20, identifies that, as depicted in FIG. 9, the player has placed an “A” block 42 in block station 4; a “C” block 40 in block station 6; and an “E” block 47 in block station 7. The microprocessor 30, as depicted in FIG. 9, then associates: the first digit 201 of the binary template 200 with the letter “A” 42 in block station 5; the second digit 202 of the binary template 200 with the letter “C” 40 in block station 6; and the third digit 203 of the binary template 200 with the letter “E” 47 in block station 7 creating the alphabetic sequence “ACE”. The microprocessor 30 looks up the alphabetic sequence “ACE” in the dictionary and locates entry 300 number 29, 301, for the word “ace” 302, 303.

The first phoneme instruction 304 instructs the microprocessor 30 that if the player presses the “A” block 42 in block station 5 to play the phoneme /\overline{a}/ 126b for the phoneme entry 126a (entry number 26 in the phoneme table) depicted in FIG. 6. The first feedback instruction 307 instructs the microprocessor 30 that if the player presses the “A” block 42 in block station 5 to light the lighting features associated with the binary digits of the binary template 200 for which a value of 1 is provided. Specifically, the first feedback instruction 307 contains the value of “05” which is the decimal equivalent of the binary representation 00101; the values in the binary template 200 are saved from left to right, so that the binary representation 00101 is saved in the first digit 201a as a “1”; in the second digit 202a as a “0”; and in the third digit 203a as a “1”.

These instructions mean that if the player presses the letter “A” in block station 5 to light the lighting feature 5b associated with block station 5 associated with the first binary digit 201a and to light the lighting feature 7b associated with block station 7 associated with the letter “E” which is in turn associated with the third binary digit 203a. The instructions are coded for the word “ace” in this way to demonstrate to the player that the letter “e” in the word “ace” effects the sound of the letter “a” in the word “ace”.

The instructions described above also mean that if the player presses the letter “E” in block station 7 to be silent (because the “e” in the word “ace” has no sound) and to light the lighting feature 5b associated with block station 5 associated with the first binary digit 201a and to light the lighting feature 7b associated with block station 7 associated with the letter “E” which is in turn associated with the third binary digit 203a.

As described above, the toy teaches the player phonics even in the absence of a recognizable word. Therefore, if the microprocessor 30 does not find the alphabetic sequence as a word in the dictionary, the toy still sounds the phonemes of the alphabetic sequence as a phoneme sequence and lights the lighting features of the block stations to indicate to the player the interplay effects between the elements of the alphabetic sequence.

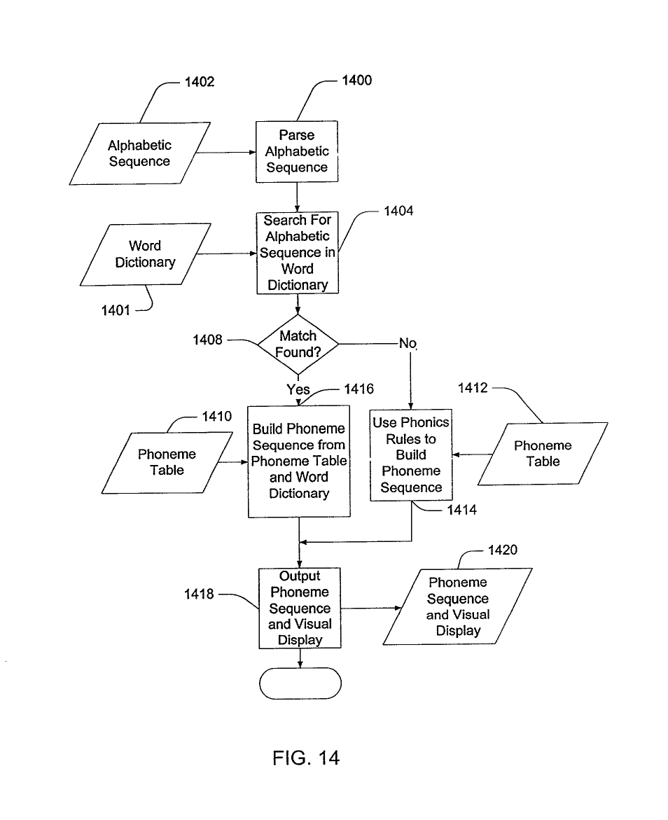

FIG. 14 is a process diagram depicting generation of a phoneme sequence within one embodiment of the present invention. The phonics engine determines an alphabetic sequence 1402 from blocks or tiles positioned in stations by a player and parsed 1400 into an internal representation of the alphabetic sequence as previously described. The phonics engine searches for the alphabetic sequence in a word dictionary 1401. If a match is found 1408 for a word and the alphabetic sequence, the phonics engine uses the coded instructions associated with the word in the word dictionary and the phoneme table 1410 to build 1416 a phoneme sequence and visual display. The phoneme sequence and visual display 1420 is outputted 1418 for presentation to the player.

If no match is found 1408 for a word and the alphabetic sequence, the phonics engine uses phonics rules 1414 and a phoneme table 1412 to build a phoneme sequence and visual display. The phoneme sequence and visual display 1420 is outputted 1418 for presentation to the player.

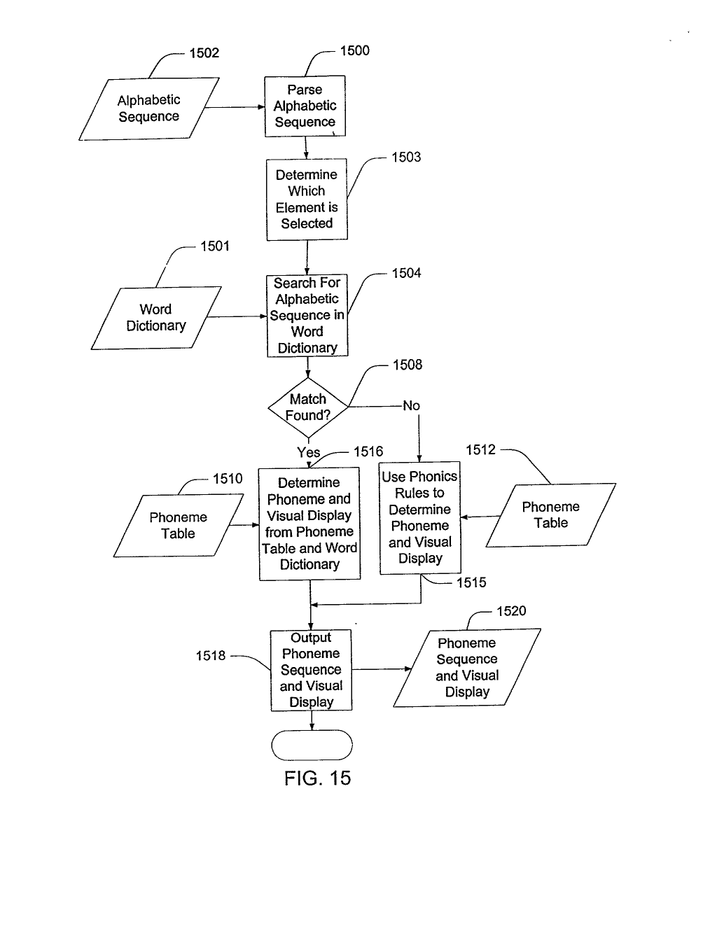

FIG. 15 is a process diagram depicting generation of a single phoneme within one embodiment of the present invention. The phonics engine determines an alphabetic sequence 1502 from blocks or tiles positioned in stations by a player and parsed 1500 into an internal representation of the alphabetic sequence as previously described. The phonics engine next determines 1503 which block or tile was selected so that a single phoneme can be generated for the selected block or tile. The phonics engine searches for the alphabetic sequence in a word dictionary 1501. If a match is found 1508 for a word and the alphabetic sequence, the phonics engine uses the coded instructions associated with the word in the word dictionary and the phoneme table 1510 to determine 1516 a phoneme and visual display. The phoneme and visual display 1520 is outputted 1518 for presentation to the player.

If no match is found 1508 for a word and the alphabetic sequence, the phonics engine uses phonics rules 1514 and a phoneme table 1512 to build a phoneme and visual display. The phoneme and visual display 1520 is outputted 1518 for presentation to the player.

In one embodiment, if the alphabetic sequence is not found in the word dictionary, the alphabetic sequence, the phoneme sequence and the visual display generated using th phonics rules are stored in the word dictionary as a virtual word for later use.

Letter Dictionary

If only a single block letter is placed in a block station, then the “dictionary” definition of the sound for that letter is played. Each dictionary definition identifies whether or not the letter is a vowel and the normal sound of the letter, using the phoneme table key. Appendix D hereto contains exemplary code that sets up a Letter Dictionary and establishes the dictionary definition for each letter.

Phonics Rules

If the microprocessor 30 does not find a word matching the alphabetic sequence in the dictionary, then the microprocessor 30 analyzes the alphabetic sequence according to a set of phonics rules in order to develop the phoneme to play when the player presses a particular letter and to develop the lighting configuration appropriate for the letters in the block station.

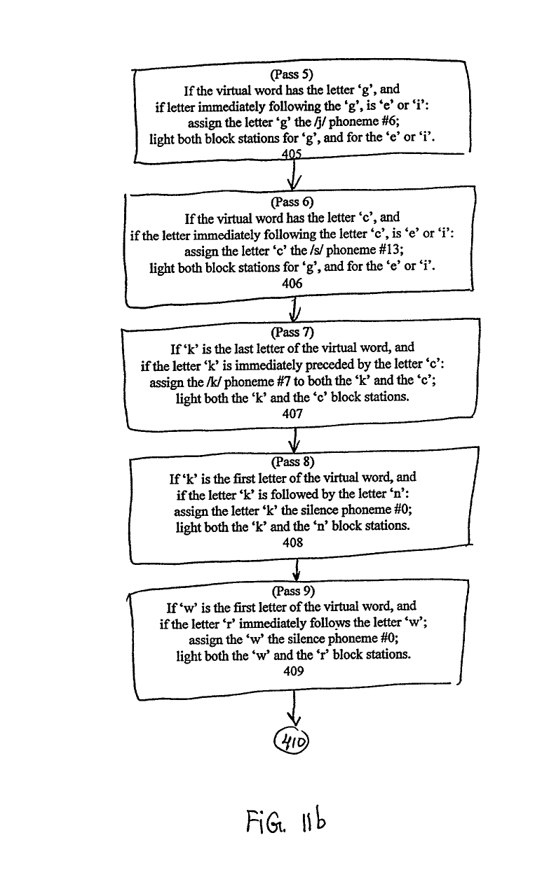

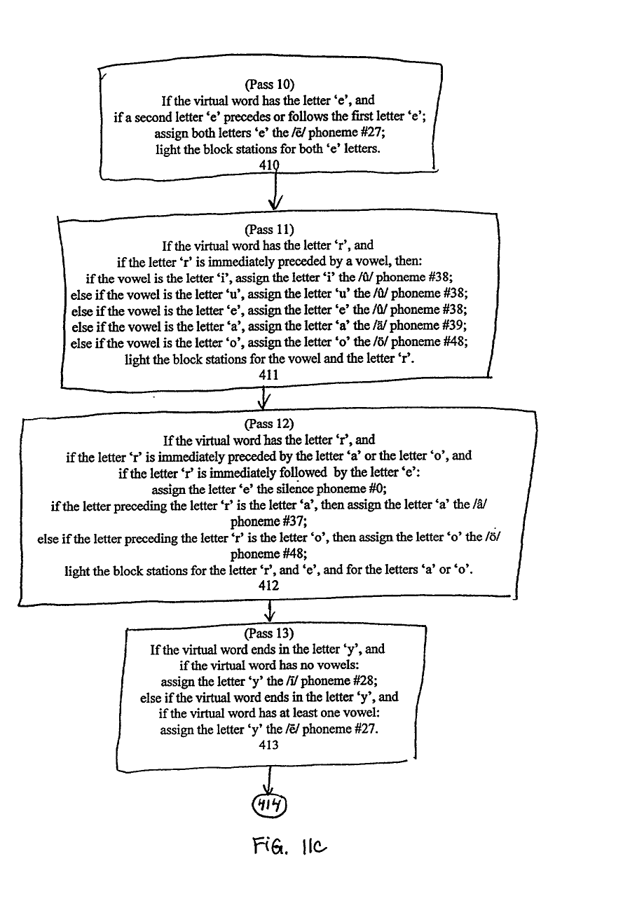

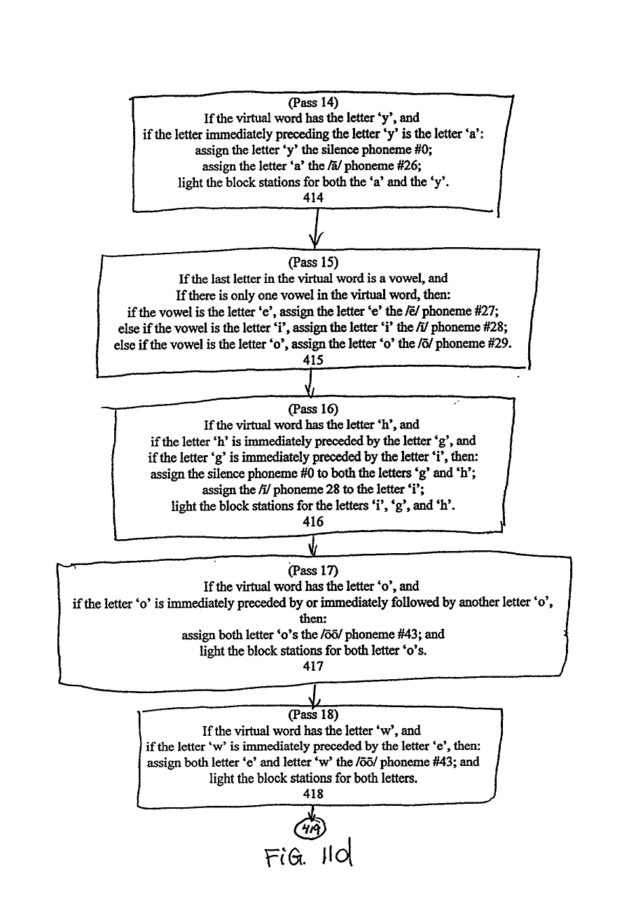

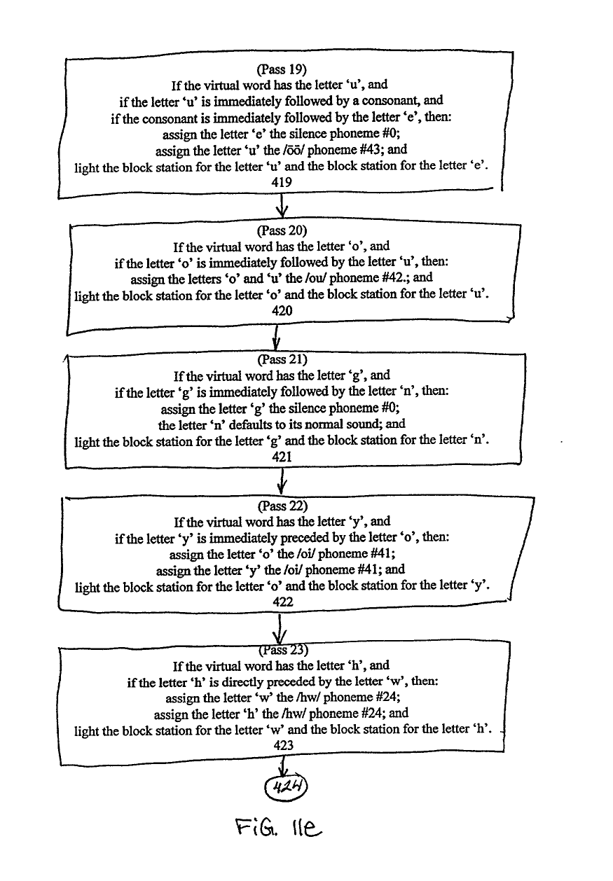

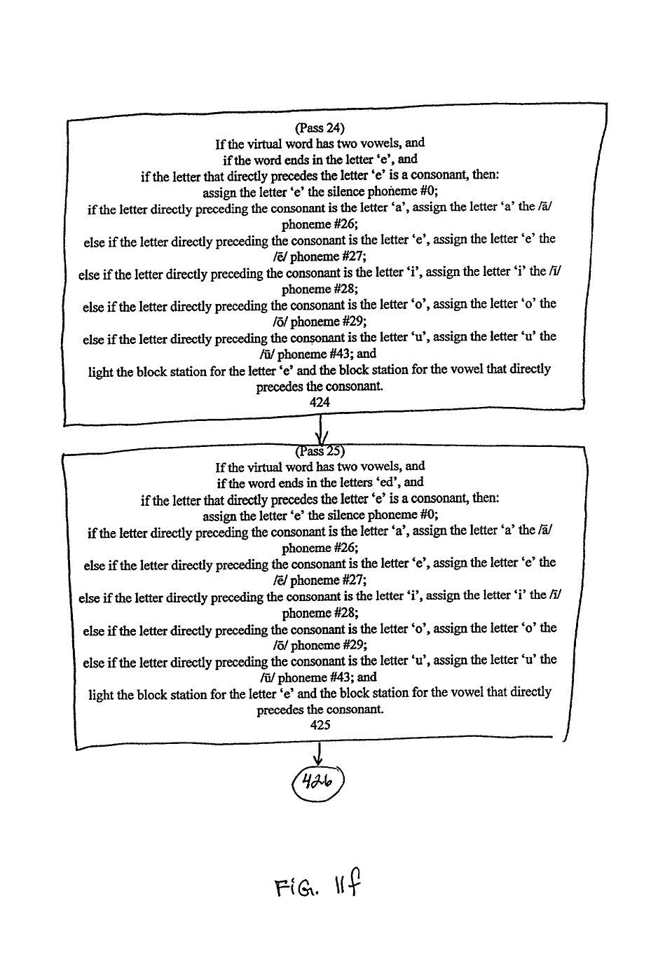

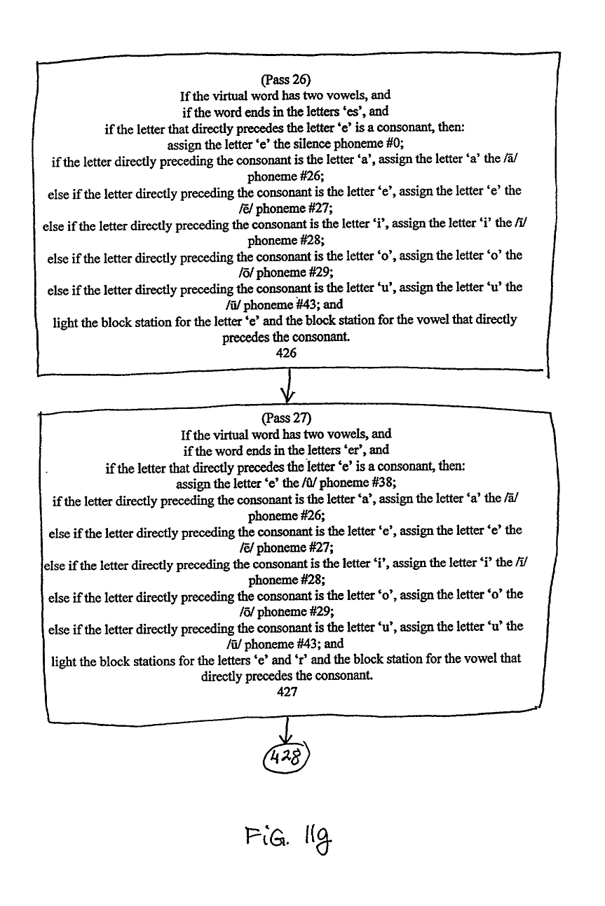

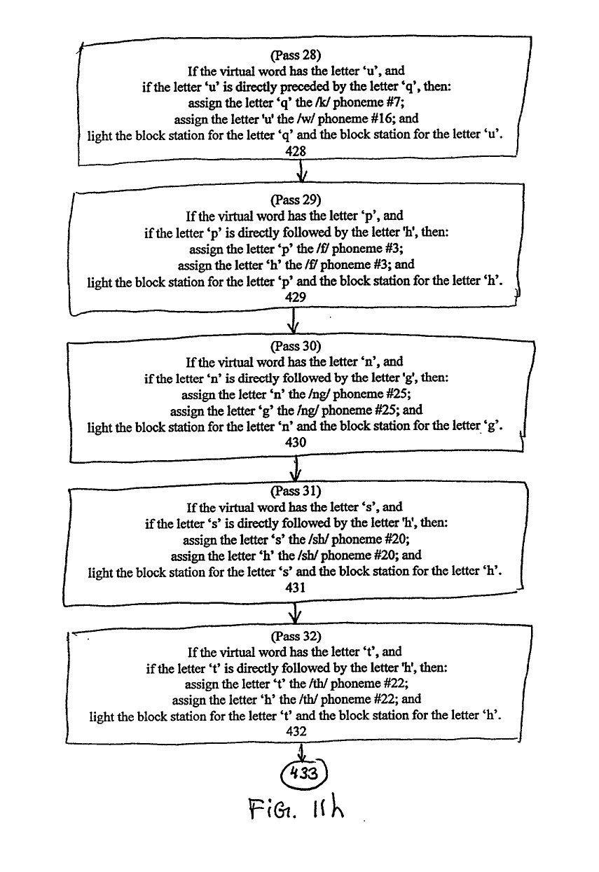

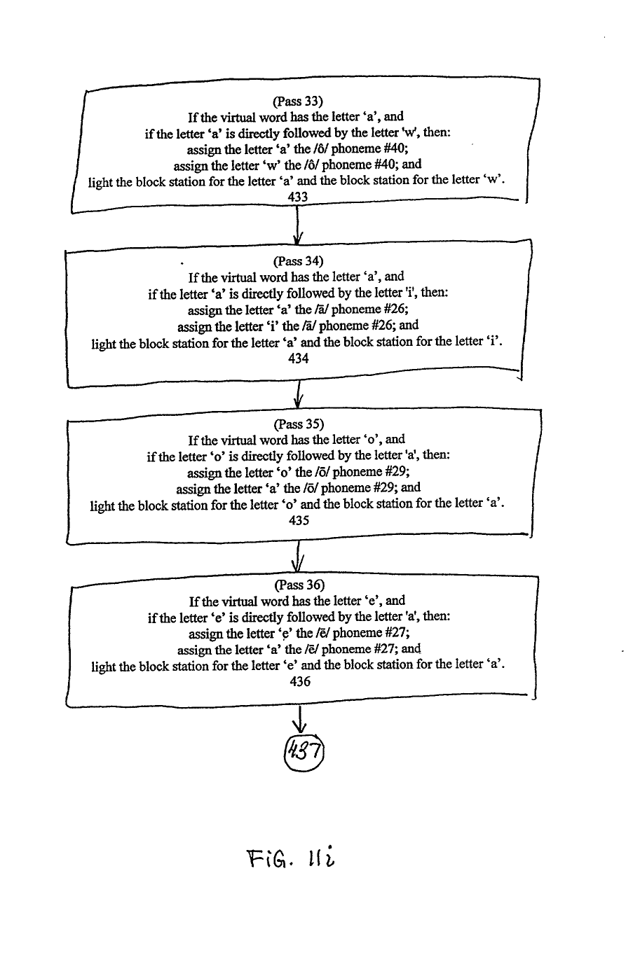

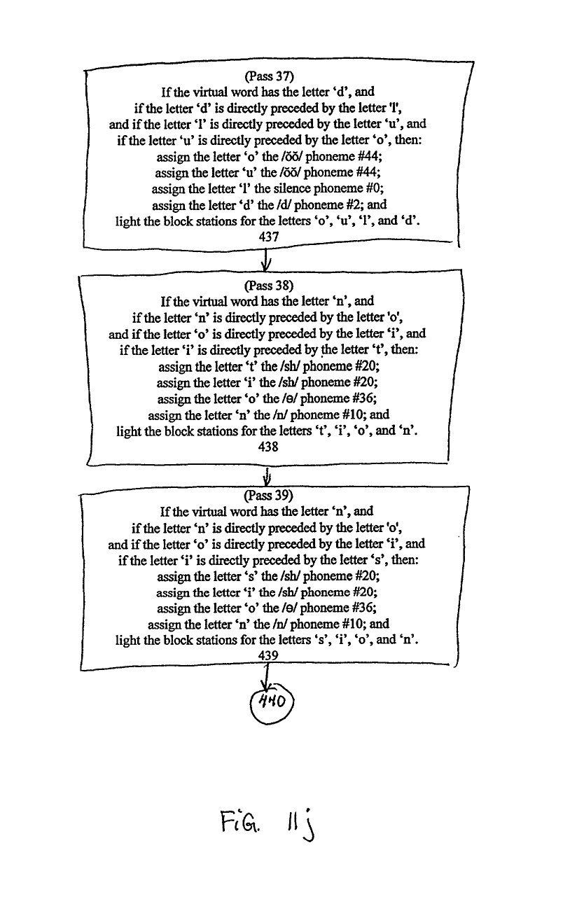

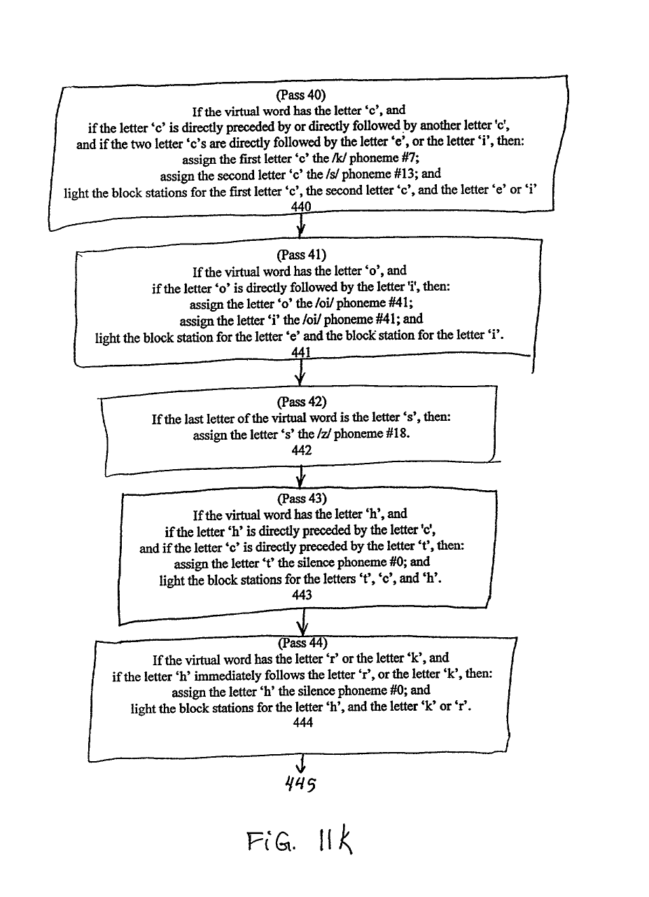

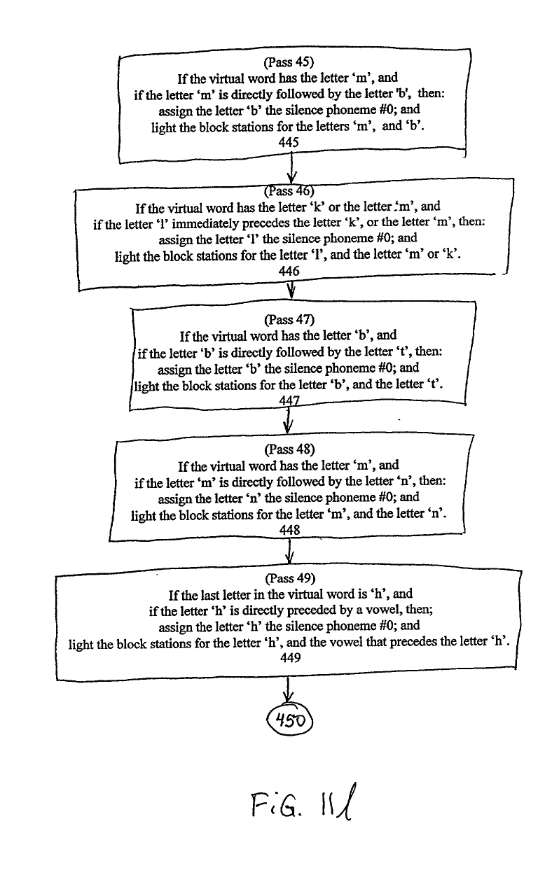

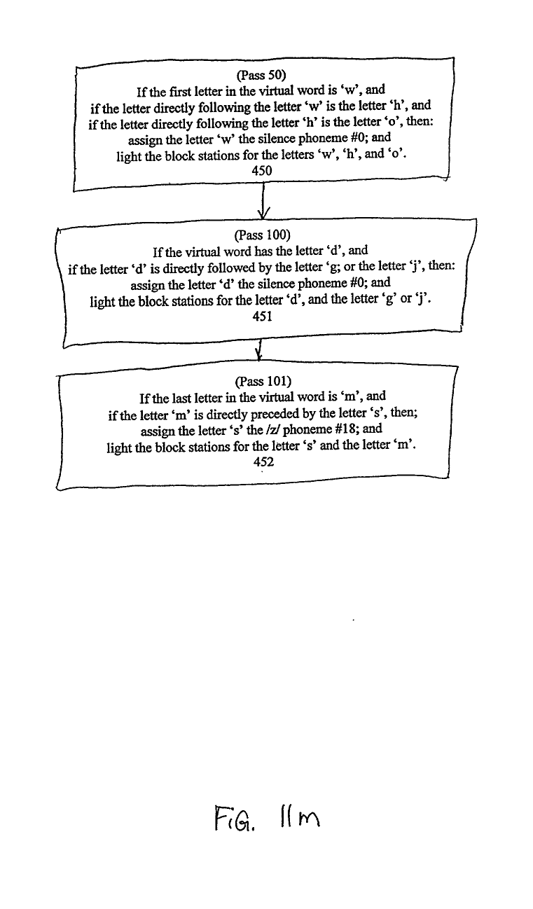

FIGS. 11a-11m are logic flow diagrams depicting the phonics rules logic flow for an exemplary embodiment of the invention. As depicted in FIGS. 11a-11m, in order to begin the phonics rules analysis, the microprocessor 30 builds a virtual word 400 dictionary entry that provides phoneme sequence and lighting feature lighting instructions in the same format as a dictionary word entry. Following is exemplary code that builds a set of null virtual words, one virtual word for each possible word length (2 through 5 letters).

/vword2 [ “empty” [ “0” “0” ] “00” “00” ] false ] def
/vword3 [ “empty” [ “0” “0” “0” ] [ “00” “00” “00” ]

false ] def

/vword4 [ “empty” [ “0” “0” “0” “0” ] [ “00” “00” “00”

“00” ] false ] def

/vword5 [ “empty” [ “0” “0” “0” “0” “0” ] [ “00” “00”

“00” “00” “00” ] false ] def

/vwordtable [ nil nil vword2 vword3 vword4 vword5 ] def

Once the microprocessor 30 builds null virtual words for each possible length of a word according to the exemplary embodiment of the invention, the microprocessor 30 executes the various tests for various possible relationships between the letters.

The exemplary code used to program the exemplary embodiment of the invention and used herein to illustrate the various features of the present invention is an original programming language.

Following is exemplary code that executes the various tests to build the virtual word dictionary entry. (the ellipses is used in the following example for brevity to indicate that all passes vpass1 through vpass50, and vpass100 through vpass101 are executed):

/virtualword {

/wlen word length def
wlen 0 gt {

/workingvword vwordtable wlen get def
50 dict begin

“pass1” debugprint

vpass1

. . .
“pass101” debugprint

vpass101

end
gc
workingvword

} if

} def

Someone with ordinary skill in the art will understand that the particular order of the execution of the phonics rules tests, as illustrated by the above code and as described below, is exemplary and is not a limitation of the invention. Other sequences of performing the tests can be devised without departing from the spirit of the invention.

In an exemplary embodiment, the microprocessor 30 applies over fifty (50) different tests (“passes”) to the letters in the block stations to determine the most appropriate phoneme and lighting feedback configuration for each letter. Appendix A hereto contains a description of the more than fifty (50) rules with which each letter is tested in an exemplary embodiment of the invention if the letters were not found to be a word in the dictionary. Appendix B hereto contains an exemplary embodiment of the code for each pass. For example, “Pass 25” in Appendix A is supported by the exemplary code under the title “vpass25” in Appendix B.

In the first pass of the exemplary embodiment, “vpass1” assigns the “normal” sound for each letter in the virtual word to each position in the phoneme instruction subtable of the virtual word table 400 as depicted in FIG. 11a. in Pass 1, the microprocessor 30 shifts through each letter of the virtual word to assign each letter its normal sound; and to light the block station for that letter 401. The following exemplary code for “vpass1” is illustrative:

/vpass1 {

0 1 wlen {

| /x exch def | |
|---|---|
| workingvword 1 get | // array |

| | |
|---|---|
| x | // array int |

| | |
|---|---|
| Alphabet word x get get | // array int dict |

| | |
|---|---|
| /snorm get | // array int |

string

put
workingvword 2 get
x 1 x bitshift put

} for

} def

If a player presses a letter block, the microprocessor 30 will light the lighting feature for the block station in which the letter block has been pressed; as described below, if the pressed letter is determined to belong to a phonetic relationship with other letters resting in other block stations, the phonics rules described below set lighting configurations to light the lighting features for the blocks in which the other letters belonging to the phonetic relationship rest.

Therefore, if a letter “X”, for example, does not belong to a phonetic relationship with any other letters in the other block stations, then if the player presses that letter “X”, the lighting feature for the block station in which the letter “X” was pressed will be lighted; if the player presses any other letter, then the lighting feature for the block station in which the letter “X” rests will not light.

On the other hand, if the letter “X” belongs to a phonetic relationship with other letters in other block stations, if the player presses the letter “X”, then the lighting features for the block station in which the letter “X” was pressed and for the block stations in which the other letters in the phonetic relationship rest will light; if the player presses one of the other letters that belong to the phonetic relationship to which the letter “X” belongs, the lighting feature for block station in which the pressed letter was pressed, as well as the block stations for the other letters, including the letter “X”, in the phonetic relationship rest, will be lighted. References to lighting a block station in the description of the logic flow depicted in FIGS. 11a-11m means setting the lighting instruction to light the lighting feature for the block station referenced.

Thereafter, each “vpass” code section analyzes the possible phonetic relationships between the letters in the virtual word, and assigns the appropriate phoneme to letters in identified phonetic relationships, using the phoneme item number from the phoneme table as depicted in FIG. 6, to each letter in the letter combination being examined. Each “vpass” code section also assigns the appropriate lighting feedback configuration for the lighting features associated with the block stations in which letters identified as part of a phonetic relationship rest.

In Pass 2 of the exemplary embodiment, the microprocessor 30 finds each consonant in the virtual word 402a. If the letter preceding a consonant is also a consonant, and if the two consonants are the same consonant, the microprocessor 30 is programmed to: assign first consonant the silence phoneme #0; allow second consonant to default to its normal sound; and light block stations for both consonants 402b.

In Pass 3 of the exemplary embodiment, if the virtual word has the letter ‘h’, and if the letter ‘c’ immediately precedes the letter ‘h’, the microprocessor 30 is programmed to: assign the /ch/ phoneme #19 to both the ‘c’ and the ‘h’; and light block stations for both ‘c’ and ‘h’ 403.

The following exemplary code for “vpass3” analyzes the letters in the virtual word for the “ch” combination of letters and is illustrative of the assignment of phoneme and lighting configuration feedback instructions:

// ch

/vpass3 {

/prev ‘.’ def
0 1 wlen {

/x exch def
word x get ‘h’ eq prey ‘c’ eq and {

x x 1 sub light2gether
“19” x soundlikethis
“19” x 1 sub soundlikethis

} if
/prev word x get def

} for

} def

In the above depicted exemplary “vpass3” code, the microprocessor 30 looks for an ‘h’. When an ‘h’ is found, the letter preceding the ‘h’ is examined to determine whether that letter preceding the ‘h’ is a ‘c’. If so, the microprocessor 30 assigns the “19” sound 119a as depicted in FIG. 6, which is the /ch/ sound 119b in the word “cheese” as depicted in FIG. 6. Further, the microprocessor 30 assigns the lighting instruction to each block in which the letters ‘c’ and ‘h’ rest.

The above exemplary code works from right to left, first looking for the letter ‘h’, at any position in the virtual word, and then looking in front of the ‘h’ for the letter ‘c’. Other “vpasses” work from left to right.

In Pass 4 of the exemplary embodiment, if the virtual word has the letter ‘t’, and if the letter immediately preceding the letter ‘t’ is the letter ‘h’, and if the letter immediately preceding the letter ‘h’ is the letter g, then the microprocessor 30 is programmed to: assign the silence phoneme #0 to both the ‘g’ and ‘h’ block stations; allow the ‘t’ letter to default to its normal sound; and light all three block stations for ‘g’ ‘h’, and ‘t’ 404.

In Pass 5 of the exemplary embodiment, if the virtual word has the letter ‘g’, and if the letter immediately following the ‘g’, is ‘e’ or ‘i’, then the microprocessor 30 is programmed to: assign the letter ‘g’ the /j/ phoneme #6; light both block stations for ‘g’, and for the ‘e’ or ‘i’ 405.

In Pass 6 of the exemplary embodiment, if the virtual word has the letter ‘c’, and if the letter immediately following the letter ‘c’, is ‘e’ or ‘i’, then the microprocessor 30 is programmed to: assign the letter ‘c’ the /s/ phoneme #13; and light both block stations for ‘g’, and for the ‘e’ or ‘i’ 406.

The following exemplary code for “vpass6” illustrates a left to right analysis approach, looking for a soft ‘c’, which is the case whenever the letter ‘c’ is followed by either the letter ‘i’ or ‘e’

// soft ‘c’

/vpass6 {

0 1 wlen 1 sub

/x exch def
word x get ‘c’ eq {

word x 1 add get ‘i’ eq
word x 1 add get ‘e’ eq
or {

x x 1 add lightthistoo
“13” x soundlikethis

} if

} if

} for

} def

In Pass 7 of the exemplary embodiment, of ‘k’ is the last letter of the virtual word, and if the letter ‘k’ is immediately preceded by the letter ‘c’, then the microprocessor 30 is programmed to: assign the /k/ phoneme #7 to both the ‘k’ and the ‘c’; and light both the ‘k’ and the ‘c’ block stations 407.

Some phonetic relationship tests, such as the above-described ‘ck’ test, look for certain letters and/or letter combinations at the ending of a word. The following exemplary code, “vpass7”, illustrates an end of a word analysis, checking for the ‘ck’ combination, such as in the word ‘check’.

// ‘ck’ at the end

/vpass7 {

word wlen 2 sub get ‘c’ eq {

word wlen 1 sub get ‘k’ eq {

wlen 2 sub wlen 1 sub light2gether
“7” wlen 2 sub soundlikethis
“7” wlen 1 sub soundlikethis

} if

} if

} def

In Pass 8 of the exemplary embodiment, if ‘k’ is the first letter of the virtual word, and if the letter ‘k’ is followed by the letter ‘n’, then the microprocessor 30 is programmed to: assign the letter ‘k’ the silence phoneme #0; and light both the ‘k’ and the ‘n’ block stations 408.

In Pass 9 of the exemplary embodiment, if ‘w’ is the first letter of the virtual word, and if the letter ‘r’ immediately follows the letter ‘w’, then the microprocessor 30 is programmed to: assign the ‘w’ the silence phoneme #O; and light both the ‘w’ and the ‘r’ block stations 409.

Some phonetic relationship tests such as the above-described ‘wr’ pass, look for certain letters and/or letter combinations at the beginning of a word. The following exemplary code, “vpass9”, illustrates a beginning of a word analysis, checking for the ‘wr’ combination, such as in the word ‘write’.

// ‘wr’ at the beginning

/vpass9 {

word 0 get ‘w’ eq

word 1 get ‘r’ eq {

0 1 lightthistoo
“0” 0 soundlikethis

} if

} if

} def

In Pass 10 of the exemplary embodiment, if the virtual word has the letter ‘e’, and if a second letter ‘e’ precedes or follows the first letter ‘e’, then: assign both letters ‘e’ the /\overline{e}/ phoneme #27; and light the block stations for both ‘e’ letters 410.

In Pass 11 of the exemplary embodiment, if the virtual word has the letter ‘r’, and if the letter ‘r’ is immediately preceded by a vowel, then: if the vowel is the letter ‘i’, assign the letter ‘i’ the /û/ phoneme #38; else if the vowel is the letter ‘u’, assign the letter ‘u’ the /û/ phoneme #38; else if the vowel is the letter ‘e’, assign the letter ‘e’ the /û/ phoneme #38; else if the vowel is the letter ‘a’, assign the letter ‘a’ the /\dot{a}/ phoneme #39; else if the vowel is the letter ‘o’, assign the letter ‘o’ the /\dot{o}/ phoneme #48; light the block stations for the vowel and the letter ‘r’ 411.

In Pass 12 of the exemplary embodiment, if the virtual word has the letter ‘r’, and if the letter ‘r’ is immediately preceded by the letter ‘a’ or the letter ‘o’, and: if the letter ‘r’ is immediately followed by the letter ‘e’, then assign the letter ‘e’ the silence phoneme #0; if the letter preceding the letter ‘r’ is the letter ‘a’, then assign the letter ‘a’ the /â/ phoneme #37; else if the letter preceding the letter ‘r’ is the letter ‘o’, then assign the letter ‘o’ the /ö/ phoneme #48; and light the block stations for the letter ‘r’, and ‘e’, and for the letters ‘a’ or ‘o’ 412.

In Pass 13 of the exemplary embodiment, if the virtual word ends in the letter ‘y’, and: if the virtual word has no vowels, then assign the letter ‘y’ the /\overline{i}/ phoneme #28; else if the virtual word ends in the letter ‘y’, and if the virtual word has at least one vowel: assign the letter ‘y’ the /\overline{e}/ phoneme #27 413.

In Pass 14 of the exemplary embodiment, if the virtual word has the letter ‘y’, and if the letter immediately preceding the letter ‘y’ is the letter ‘a’, then: assign the letter ‘y’ the silence phoneme #0; assign the letter ‘a’ the /\overline{a}/ phoneme #26; and light the block stations for both the ‘a’ and the ‘y’ 414.

In Pass 15 of the exemplary embodiment, if the last letter in the virtual word is a vowel, and if there is only one vowel in the virtual word, then: if the vowel is the letter ‘e’, assign the letter ‘e’ the /\overline{e}/ phoneme #27; else if the vowel is the letter ‘i’, assign the letter ‘i’ the /\overline{i}/ phoneme #28; else if the vowel is the letter ‘o’, assign the letter ‘o’ the /\overline{o}/ phoneme #29 415. In Pass 16 of the exemplary embodiment, if the virtual word has the letter ‘h’, and if the letter ‘h’ is immediately preceded by the letter ‘g’, and if the letter ‘g’ is immediately preceded by the letter ‘i’, then: assign the silence phoneme #0 to both the letters ‘g’ and ‘h’; assign the /\overline{i}/ phoneme 28 to the letter ‘i’; and light the block stations for the letters ‘i’, ‘g’, and ‘h’ 416.

In Pass 17 of the exemplary embodiment, if the virtual word has the letter ‘o’, and if the letter ‘c’ is immediately preceded by or immediately followed by another letter ‘o’, then: assign both letter ‘o’s the /\overline{o}\overline{o}/ phoneme #43; and light the block stations for both letter ‘o’s 417.

In Pass 18 of the exemplary embodiment, if the virtual word has the letter ‘w’, and if the letter ‘w’ is immediately preceded by the letter ‘e’, then: assign both letter ‘e’ and letter ‘w’ the /\overline{o}\overline{o}/ phoneme #43; and light the block stations for both letters 418.

In Pass 19 of the exemplary embodiment, if the virtual word has the letter ‘u’, and if the letter ‘u’ is immediately followed by a consonant, and if the consonant is immediately followed by the letter ‘e’, then: assign the letter ‘e’ the silence phoneme #0; assign the letter ‘u’ the /\overline{o}\overline{o}/ phoneme #43; and light the block station for the letter ‘u’ and the block station for the letter ‘e’ 419.

In Pass 20 of the exemplary embodiment, if the virtual word has the letter ‘o’, and if the letter ‘o’ is immediately followed by the letter ‘u’, then: assign the letters ‘o’ and ‘u’ the /ou/ phoneme #42; and light the block station for the letter ‘o’ and the block station for the letter ‘u’ 420.

In Pass 21 of the exemplary embodiment, if the virtual word has the letter ‘g’, and if the letter ‘g’ is immediately followed by the letter ‘n’, then: assign the letter ‘g’ the silence phoneme #0; the letter ‘n’ defaults to its normal sound; and light the block station for the letter ‘g’ and the block station for the letter ‘n’ 421.

In Pass 22 of the exemplary embodiment, if the virtual word has the letter ‘y’, and if the letter ‘y’ is immediately preceded by the letter ‘o’, then: assign the letter ‘o’ the /oi/ phoneme #41; assign the letter ‘y’ the /oi/ phoneme #41; and light the block station for the letter ‘o’ and the block station for the letter ‘y’ 422.

In Pass 23 of the exemplary embodiment, if the virtual word has the letter ‘h’, and if the letter ‘h’ is directly preceded by the letter ‘w’, then: assign the letter ‘w’ the /hw/ phoneme #24; assign the letter ‘h’ the /hw/ phoneme #24; and light the block station for the letter ‘w’ and the block station for the letter ‘h’ 423.

In Pass 24 of the exemplary embodiment, if the virtual word has two vowels, and if the word ends in the letter ‘e’, and if the letter that directly precedes the letter ‘e’ is a consonant, then: assign the letter ‘e’ the silence phoneme #0; if the letter directly preceding the consonant is the letter ‘a’, assign the letter ‘a’ the /\overline{a}/ phoneme #26; else if the letter directly preceding the consonant is the letter ‘e’, assign the letter ‘e’ the /\overline{e}/ phoneme #27; else if the letter directly preceding the consonant is the letter ‘i’, assign the letter ‘i’ the /\overline{i}/ phoneme #28; else if the letter directly preceding the consonant is the letter ‘o’, assign the letter ‘o’ the /\overline{o}/ phoneme #29; else if the letter directly preceding the consonant is the letter ‘u’, assign the letter ‘u’ the /\overline{u}/ phoneme #43; and light the block station for the letter ‘e’ and the block station for the vowel that directly precedes the consonant 424.

In Pass 25 of the exemplary embodiment, if the virtual word has two vowels, and if the word ends in the letters ‘ed’, and if the letter that directly precedes the letter ‘e’ is a consonant, then: assign the letter ‘e’ the silence phoneme #0; if the letter directly preceding the consonant is the letter ‘a’, assign the letter ‘a’ the /\overline{a}/ phoneme #26; else if the letter directly preceding the consonant is the letter ‘e’, assign the letter ‘e’ the /\overline{e}/ phoneme #27; else if the letter directly preceding the consonant is the letter ‘i’, assign the letter ‘i’ the /\overline{i}/ phoneme #28; else if the letter directly preceding the consonant is the letter ‘o’, assign the letter ‘o’ the /\overline{o}/ phoneme #29; else if the letter directly preceding the consonant is the letter ‘u’, assign the letter ‘u’ the /\overline{u}/ phoneme #43; and light the block station for the letter ‘e’ and the block station for the vowel that directly precedes the consonant 425.

In Pass 26 of the exemplary embodiment, if the virtual word has two vowels, and if the word ends in the letters ‘es’, and if the letter that directly precedes the letter ‘e’ is a consonant, then: assign the letter ‘e’ the silence phoneme #0; if the letter directly preceding the consonant is the letter ‘a’, assign the letter ‘a’ the /\overline{a}/ phoneme #26; else if the letter directly preceding the consonant is the letter ‘e’, assign the letter ‘e’ the /\overline{e}/ phoneme #27; else if the letter directly preceding the consonant is the letter ‘i’, assign the letter ‘i’ the /\overline{i}/ phoneme #28; else if the letter directly preceding the consonant is the letter ‘o’, assign the letter ‘o’ the /\overline{o}/ phoneme #29; else if the letter directly preceding the consonant is the letter ‘u’, assign the letter ‘u’ the /\overline{u}/ phoneme #43; and light the block station for the letter ‘e’ and the block station for the vowel that directly precedes the consonant 426.

In Pass 27 of the exemplary embodiment, if the virtual word has two vowels, and if the word ends in the letters ‘er’, and if the letter that directly precedes the letter ‘e’ is a consonant, then: assign the letter ‘e’ the /û/ phoneme #38; if the letter directly preceding the consonant is the letter ‘a’, assign the letter ‘a’ the /\overline{a}/ phoneme #26; else if the letter directly preceding the consonant is the letter ‘e’, assign the letter ‘e’ the /\overline{e}/ phoneme #27; else if the letter directly preceding the consonant is the letter ‘i’, assign the letter ‘i’ the /\overline{i}/ phoneme #28; else if the letter directly preceding the consonant is the letter ‘o’, assign the letter ‘o’ the /\overline{o}/ phoneme #29; else if the letter directly preceding the consonant is the letter ‘u’, assign the letter ‘u’ the /\overline{o}/ phoneme #43; and light the block stations for the letters ‘e’ and ‘r’ and the block station for the vowel that directly precedes the consonant 427.

In Pass 28 of the exemplary embodiment, if the virtual word has the letter ‘u’, and if the letter ‘u’ is directly preceded by the letter ‘q’, then: assign the letter ‘q’ the /k/ phoneme #7; assign the letter ‘u’ the /w/ phoneme #16; and light the block station for the letter ‘q’ and the block station for the letter ‘u’ 428.

In Pass 29 of the exemplary embodiment, if the virtual word has the letter ‘p’, and if the letter ‘p’ is directly followed by the letter ‘h’, then: assign the letter ‘p’ the /f/ phoneme #3; assign the letter ‘h’ the /f/ phoneme #3; and light the block station for the letter ‘p’ and the block station for the letter ‘h’ 429.

In Pass 30 of the exemplary embodiment, if the virtual word has the letter ‘n’, and if the letter ‘n’ is directly followed by the letter ‘g’, then: assign the letter ‘n’ the /ng/ phoneme #25; assign the letter ‘g’ the /ng/ phoneme #25; and light the block station for the letter ‘n’ and the block station for the letter ‘g’ 430.

In Pass 31 of the exemplary embodiment, if the virtual word has the letter ‘s’, and if the letter ‘s’ is directly followed by the letter ‘h’, then: assign the letter ‘s’ the /sh/ phoneme #20; assign the letter ‘h’ the /sh/ phoneme #20; and light the block station for the letter ‘s’ and the block station for the letter ‘h’ 431.

In Pass 32 of the exemplary embodiment, if the virtual word has the letter ‘t’, and if the letter ‘t’ is directly followed by the letter ‘h’, then: assign the letter ‘t’ the /th/ phoneme #22; assign the letter ‘h’ the /th/ phoneme #22; and light the block station for the letter ‘t’ and the block station for the letter ‘h’ 432.

In Pass 33 of the exemplary embodiment, if the virtual word has the letter ‘a’, and if the letter ‘a’ is directly followed by the letter ‘w’, then: assign the letter ‘a’ the /ô/ phoneme #40; assign the letter ‘w’ the /ô/ phoneme #40; and light the block station for the letter ‘a’ and the block station for the letter ‘w’ 433.

In Pass 34 of the exemplary embodiment, if the virtual word has the letter ‘a’, and if the letter ‘a’ is directly followed by the letter ‘i’, then: assign the letter ‘a’ the /\overline{a}/ phoneme #26; assign the letter ‘i’ the /\overline{a}/ phoneme #26; and light the block station for the letter ‘a’ and the block station for the letter ‘i’ 434.

In Pass 35 of the exemplary embodiment, if the virtual word has the letter ‘o’, and if the letter ‘o’ is directly followed by the letter ‘a’, then: assign the letter ‘o’ the /\overline{o}/ phoneme #29; assign the letter ‘a’ the /\overline{o}/ phoneme #29; and light the block station for the letter ‘o’ and the block station for the letter ‘a’ 435.

In Pass 36 of the exemplary embodiment, if the virtual word has the letter ‘e’, and if the letter ‘e’ is directly followed by the letter ‘a’, then: assign the letter ‘e’ the /\overline{e}/ phoneme #27; assign the letter ‘a’ the /\overline{e}/ phoneme #27; and light the block station for the letter ‘e’ and the block station for the letter ‘a’ 436.

In Pass 37 of the exemplary embodiment, if the virtual word has the letter ‘d’, and if the letter ‘d’ is directly preceded by the letter ‘l’, and if the letter ‘l’ is directly preceded by the letter ‘u’, and if the letter ‘u’ is directly preceded by the letter ‘o’, then: assign the letter ‘o’ the / [symbol] [symbol] / phoneme #44; assign the letter ‘u’ the / [symbol] [symbol] / phoneme #44; assign the letter ‘l’ the silence phoneme #0; assign the letter ‘d’ the /d/ phoneme #2; and light the block stations for the letters ‘o’, ‘u’, ‘l’, and ‘d’ 437.

In Pass 38 of the exemplary embodiment, if the virtual word has the letter ‘n’, and if the letter ‘n’ is directly preceded by the letter ‘o’, and if the letter ‘c’ is directly preceded by the letter ‘i’, and if the letter ‘i’ is directly preceded by the letter ‘t’, then: assign the letter ‘t’ the /sh/ phoneme #20; assign the letter ‘i’ the /sh/ phoneme #20; assign the letter ‘o’ the /e/ phoneme #36; assign the letter ‘n’ the /n/ phoneme #10; and light the block stations for the letters ‘t’, ‘i’, ‘o’, and ‘in’ 438.

In Pass 39 of the exemplary embodiment, if the virtual word has the letter ‘n’, and if the letter ‘n’ is directly preceded by the letter ‘o’, and if the letter ‘o’ is directly preceded by the letter ‘i’, and if the letter ‘i’ is directly preceded by the letter ‘s’, then: assign the letter ‘s’ the /sh/ phoneme #20; assign the letter ‘i’ the /sh/ phoneme #20; assign the letter ‘o’ the / [symbol] / phoneme #36; assign the letter ‘n’ the /n/ phoneme #10; and light the block stations for the letters ‘s’, ‘i’, ‘o’, and ‘n’ 439.

In Pass 40 of the exemplary embodiment, if the virtual word has the letter ‘c’, and if the letter ‘c’ is directly preceded by or directly followed by another letter ‘c’, and if the two letter ‘c’s are directly followed by the letter ‘e’, or the letter ‘i’, then: assign the first letter ‘c’ the /k/ phoneme #7; assign the second letter ‘c’ the /s/ phoneme #13; and light the block stations for the first letter ‘c’, the second letter ‘c’, and the letter ‘e’ or ‘i’ 440.

In Pass 41 of the exemplary embodiment, if the virtual word has the letter ‘o’, and if the letter ‘o’ is directly followed by the letter ‘i’, then: assign the letter ‘o’ the /oi/ phoneme #41; assign the letter ‘i’ the /oi/ phoneme #41; and light the block station for the letter ‘e’ and the block station for the letter ‘i’ 441.

In Pass 42 of the exemplary embodiment, if the last letter of the virtual word is the letter ‘s’, then: assign the letter ‘s’ the /z/ phoneme #18 442.

In Pass 43 of the exemplary embodiment, if the virtual word has the letter ‘h’, and if the letter ‘h’ is directly preceded by the letter ‘c’, and if the letter ‘c’ is directly preceded by the letter ‘t’, then: assign the letter ‘t’ the silence phoneme #0; and light the block stations for the letters ‘t’, ‘c’, and ‘h’ 443.

In Pass 44 of the exemplary embodiment, if the virtual word has the letter ‘r’ or the letter ‘k’, and if the letter ‘h’ immediately follows the letter ‘r’, or the letter ‘k’, then: assign the letter ‘h’ the silence phoneme #0; and light the block stations for the letter ‘h’, and the letter ‘k’ or ‘r’ 444.

In Pass 45 of the exemplary embodiment, if the virtual word has the letter ‘m’, and if the letter ‘m’ is directly followed by the letter ‘b’, then: assign the letter ‘b’ the silence phoneme #0; and light the block stations for the letters ‘m’, and ‘b’ 445.

In Pass 46 of the exemplary embodiment, if the virtual word has the letter ‘k’ or the letter ‘m’, and if the letter ‘l’ immediately precedes the letter ‘k’, or the letter ‘m’, then: assign the letter ‘l’ the silence phoneme #0; and light the block stations for the letter ‘l’, and the letter ‘m’ or ‘k’ 446.

In Pass 47 of the exemplary embodiment, if the virtual word has the letter ‘b’, and if the letter ‘b’ is directly followed by the letter ‘t’, then: assign the letter ‘b’ the silence phoneme #0; and light the block stations for the letter ‘b’, and the letter ‘t’ 447.

In Pass 48 of the exemplary embodiment, if the virtual word has the letter ‘m’, and if the letter ‘m’ is directly followed by the letter ‘n’, then: assign the letter ‘n’ the silence phoneme #0; and light the block stations for the letter ‘m’, and the letter ‘n’ 448.

In Pass 49 of the exemplary embodiment, if the last letter in the virtual word is ‘h’, and if the letter ‘h’ is directly preceded by a vowel, then; assign the letter ‘h’ the silence phoneme #0; and light the block stations for the letter ‘h’, and the vowel that precedes the letter ‘h’ 449.

In Pass 50 of the exemplary embodiment, if the first letter in the virtual word is ‘w’, and if the letter directly following the letter ‘w’ is the letter ‘h’, and if the letter directly following the letter ‘h’ is the letter ‘o’, then: assign the letter ‘w’ the silence phoneme #0; and light the block stations for the letters ‘w’, ‘h’, and ‘o’ 450.

In Pass 100 of the exemplary embodiment, if the virtual word has the letter ‘d’, and if the letter ‘d’ is directly followed by the letter ‘g; or the letter ‘j’, then: assign the letter ‘d’ the silence phoneme #0; and light the block stations for the letter ‘d’, and the letter ‘g’ or ‘j’ 451.

In Pass 101 of the exemplary embodiment, if the last letter in the virtual word is ‘m’, and if the letter ‘m’ is directly preceded by the letter ‘s’, then; assign the letter ‘s’ the /z/ phoneme #18; and light the block stations for the letter ‘s’ and the letter ‘m’ 452.

Exemplary code to instruct the lighting features associated with two adjacent blocks that have been identified as phonetically related (e.g., ‘oh’ as in the word “cheese”) is depicted below:

/light2gether {

/x1 exch def
/x2 exch def
/lights workingvword 2 get def
lights x1 lights x1 get 1 x2 bitshift or put
lights x2 lights x2 get 1 x1 bitshift or put

} def

Exemplary code to instruct the lighting features associated with three adjacent blocks that have been identified as phonetically related (e.g., ‘ght’ as in the word “light”) is depicted below:

/light3gether {

/x3 exch def
/x2 exch def
/x1 exch def
/lights workingvword 2 get def
lights x1 lights x1 get 1 x2 bitshift or put
lights x1 lights x1 get 1 x3 bitshift or put
lights x2 lights x2 get 1 x1 bitshift or put
lights x2 lights x2 get 1 x3 bitshift or put
lights x3 lights x3 get 1 x1 bitshift or put
lights x3 lights x3 get 1 x2 bitshift or put

} def

Exemplary code to instruct the lighting features associated with other blocks that have been identified as phonetically related (e.g., the silent ‘e’ at the end of a word with a vowel followed by a consonant, such as in the word “chase”, is lighted when the player presses the ‘a’ block) is depicted below:

/lightthistoo {

/x2 exch def
/x1 exch def
/lights workingvword 2 get def
lights x1 lights x1 get 1 x2 bitshift or put

} def

The above lighting configuration instructions set bits in the binary template 200, the first digit of which is aligned with the player's left-most block station in which a block has been placed. Bits corresponding to the block stations to be lighted are set to “1”. When all “vpasses” have been completed, the microprocessor 30 sends signals according to the lighting configuration instructions to the lighting circuitry associated with each block station.

Sensing Device

As mentioned above, each block station 3-7 has a floor surface 3a-7a, underneath of each of which is provided an electronic sensing device 20 as depicted in FIGS. 3a-3c, each of which is provided with its own set of analog and digital electronics as described below and as disclosed in detail in copending U.S. Utility Patent Application attorney docket number 37539/FLC/N240, the disclosure of which has previously been incorporated here by reference as if fully stated here for all purposes.

Some of the FIGURES from copending U.S. Utility Patent Application attorney docket number 37539/FLC/N240 are referred to below and are attached in Appendix C hereto. References to the FIGURES of this co-pending application and to the elements thereof are underlined to distinguish these references from the references to the FIGURES that are listed and described above.

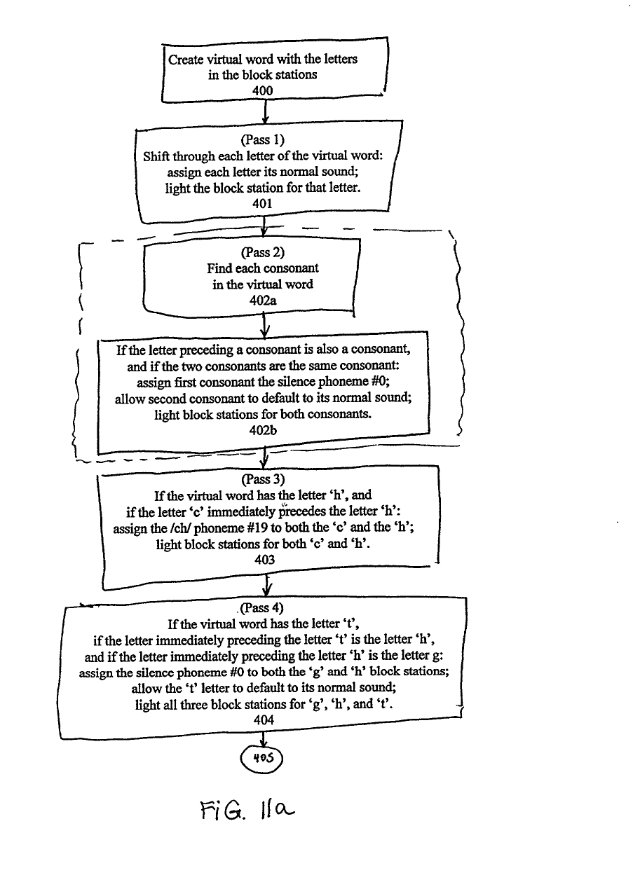

In the exemplary embodiment of the invention depicted in, e.g. FIG. 1, each block face, e.g., 701a-701f as depicted in FIG. 10, contains on its inner surface an electrically conductive pattern that provides a unique identification of the letter depicted on the outer surface of the opposing face of the block. Exemplary identification patterns are depicted in FIGS. 20c and 21a to Appendix C and will be described below in more detail.

A. The Electronic Sensing Unit.

Underneath the floor surface 3a-7a of each block station 3-7 is an electronic sensing device, an exemplary embodiment of which is depicted in the schematic diagrams provided in FIGS. 2 and 3 to Appendix C. The electronic sensing device comprises a microprocessor 1, a set of drive electrodes 2-33, a series of shift registers 35-38, and a set of at least one pickup electrode 61 configured as part of an analog circuit which is connected to an analog to digital converter 62 which communicates measured pulses to the microprocessor 1.

As depicted in FIG. 2 to Appendix C, the microprocessor 1 is connected to a set of shift registers 35-38 configured in a series. Each of the shift registers 35-38 has an input 39-42 respectively and a plurality of outputs. For example, shift register 35 has outputs 43-50.

The input 39 of the first shift register 35 in the series is connected to the microprocessor 1. Each shift register output, e.g., 43-50, is connected to one of the drive electrodes, e.g., 2-9. The microprocessor 1 is programmed to digitally generate drive signals to each of said drive electrodes 2-33 through the shift registers 35-38.

During the time that the base sensing unit is turned on, the microprocessor 1, as depicted in FIG. 2 to Appendix C, repeatedly initiates consecutive sensing cycles. Each sensing cycle consists of the microprocessor 1 consecutively stimulating, or “firing”, drive electrodes 2 through 33. Simultaneous with the firing of each drive electrode, the microprocessor 1 is programmed to wait for specified amount of time, referred to herein as the “response time.” At the expiration of the response time, the microprocessor 1 instructs the analog to digital converter 62 to measure a pulse received from the analog pickup electrode circuitry depicted in FIG. 3 to Appendix C.

The response time is the amount of time that it takes for the particular circuitry to conduct an impulse picked up by the pickup electrode 61, and send the impulse through the operational amplifiers 63-65 to the analog to digital converter 62. The response time is measured, such as through laboratory testing of the circuitry or by sending a test impulse through the analog circuitry. A test impulse of a certain magnitude can be sent when the base unit 1 as depicted in FIG. 1 is first turned on from the microprocessor 1 to the pickup electrode 61. In the case of the test impulse, the microprocessor 1 instructs the analog to digital converter 62 to communicate each changed impulse received until the microprocessor 1 receives an impulse equal to the magnitude of the test impulse. The microprocessor 1 measures the elapsed time between the time that the test impulse is sent and the time that an impulse is received with the magnitude equal to the test impulse.

During the time that the base sensing unit is turned on, the microprocessor 1 repeatedly initiates a new sensing cycle as soon as it has completed the previous sensing cycle.

As depicted in FIG. 3 to Appendix C, the pickup electrode 61 is part of an analog circuit. The pickup electrode is connected to a set of operational amplifiers 63-65, (sometimes referred to as “op amps”) for amplifying induced charge pulses picked up by the pickup electrode 61. In one embodiment, operational amplifier model LM324 is used, as depicted in FIG. 3 to Appendix C. As depicted in FIG. 6 to Appendix C, the pickup electrode 61 is configured in the central area of a circular planar array of drive electrodes.

The analog circuit has a plurality of outputs through a connection 67 to the analog digital converter 62. The analog digital converter 62 in the embodiment depicted in FIG. 2 to Appendix C is part of the microprocessor 1. The analog to digital converter 62 feeds the measured pulses to microprocessor 1. In other embodiments, the analog to digital converter is separate from the microprocessor 1 as is depicted and as will be discussed below in connection with FIG. 12 to Appendix C.

An output of the analog circuit is a pair of pulses, one going positive; the other going negative. Each pulse is measured by the analog digital converter 62. The height difference between the pulses is used to determine whether the response is a “0” or a “1”. The timing of these pulses in relationship to the shifting of the stimulus drive signal is used by the microprocessor 1 to determine the identification code of a block in a block station 3-7.

The microprocessor 1 is programmed to recognize as a “1” T a certain range of voltage. The identification of a range is dependent upon the particular hardware component selected to act as the microprocessor 1. It is useful, but not a limitation of the invention, to set the range of voltage to be recognized as a “1” to be greater than or equal to half the amount that is the total of the maximum voltage expected for a “1” and the minimum voltage expected for a “0”.

A general expression of the number of measurements taken is that there are “N” drive electrodes, “N” corresponding pattern pieces in the identifying pattern, and “N” measurements made for each sensing cycle, resulting in an “N” bit binary value for each cycle. Encoding of an identification of a particular object is discussed below.

The microprocessor 1 deduces the distance between a block and the sensing array of drive and pickup electrodes for the particular block station 3-7 in which the block rests by calculating the difference between the pulse height, or pulse magnitude, measured by the pickup electrode 61 as compared to a table of calibrated impulse measurements. As was explained above, determination of the distance information is used to place the base unit 1 of the toy in different modes of operation.

FIGS. 4a and 4b to Appendix C are semi-schematic diagrams of a partial view of a single drive electrode, e.g., 2, as embodied in a circular planar array 200 of drive electrodes as shown in FIG. 6 to Appendix C. FIG. 4a to Appendix C is a top view of a single drive electrode 2; FIG. 4b to Appendix C is the underneath view of drive electrode 2; FIG. 6 to Appendix C is a schematic diagram depicting the underneath side of an exemplary embodiment of a circuit board comprising the hardware components of the base sensing device aspect of the invention. As depicted in FIG. 4a to Appendix C, the top surface of drive electrode 2 comprises a pie-shaped wedge of electrically conductive material 2-1. A four-sided embodiment is depicted in FIG. 21a to Appendix C.

A cylinder of electrically conductive material 2-2 pierces through from the top electrically conductive surface 2-1 of drive electrode 2 through to a surface of nonconductive material, such as a shielding ground layer 85, underneath the electrically conductive layer 2-1 of drive electrode 2 as depicted in FIG. 4b to Appendix C. It should be noted that the detailed view of the underneath surface of the shielding ground layer 85 as depicted in FIG. 4b to Appendix C is not an indication of any particular shape of the shielding ground layer 85.

The top end 2-2a of the electrically conductive cylinder contacts the pie-shaped wedge of electrically conductive material 2-1. As is depicted in FIG. 4b, the underneath end 2-2b of the electrically conductive cylinder is exposed for a connection 43, in this configuration, to a shift register 35 as depicted in FIG. 2 to Appendix C. General references herein to a drive electrode use the unqualified reference numeral, e.g., 2 which includes the electrically conductive cylinder, e.g., 2-2 (and the cylinder's top end 2-2a and the cylinder's bottom end 2-2b) as well as the electrically conductive surface material such as the pie-shaped wedge, e.g., 2-1, depicted in FIG. 4a to Appendix C.

The microprocessor 1 fires a drive signal to shift register 35 which is sent to drive electrode 2 through connection 43. The drive signal is conducted from the underneath end 2-2b to the top end 2-2a of the electrically conductive cylinder to the top surface 2-1 of the electrode 2. The drive electrodes 2-33 in the sensing device as previously discussed are configured in an array, an exemplary configuration of which is a circular planar array 200 on the surface of a circuit board as depicted in FIG. 6 to Appendix C. Those with ordinary skill in the art will understand that other embodiments of the invention use other configurations of the drive electrodes without departing from the spirit of the invention.

In the same plane with the drive electrodes 2-33, one or more pickup electrodes are configured. In the embodiment of the invention depicted in FIG. 6 to Appendix C, a single pickup electrode 61 is configured in the same plane of the planar array 200 of pickup electrodes 2-33. In the four-sided configuration depicted in FIGS. 20a, 20c and 21a to Appendix C, only 12 electrodes 2-13 are provided.

As depicted in a detail view of electrode 2 in FIG. 11 to Appendix C, an exemplary embodiment provides that each drive electrode is isolated from each other drive electrode and from the pickup electrode 61, by a combination of electrically nonconductive material, e.g., 202-2 and 207, and electrically conductive material 201-2. That is, the isolation bands comprise electrically conductive material 201-2 in between electrically nonconductive material, e.g., 202-2 and 207. The electrically conductive material in the isolation band is grounded, e.g., 201-1 is connected to the ground circuitry 70 depicted in FIG. 3 to Appendix C. This type of isolation band combination is depicted in further detail in a four-sided planar embodiment of the sensing device depicted in FIG. 21a to Appendix C. Throughout the description of this invention, reference to elements of figures with a cross-hatch pattern or darkened shading indicates that the material referenced is electrically conductive material.

B. The Object to be Sensed.

Turning to the configuration of the object to be identified, in the exemplary embodiment described herein, the object is a block 701 with six faces 701a-701f as depicted in FIG. 10. Inside each of the six faces 701a-701f is an identifying pattern made of electrically conductive material such as the exemplary identifying pattern depicted in FIG. 20c to Appendix C. In the exemplary embodiment described here, the identifying pattern inside the surface of a face of a block identifies the letter represented on the opposing face of the block. For example, as depicted in FIG. 10, an identifying pattern inside the surface of block face 701e identifies as the letter “A” the letter exposed on the outside surface of block face 701a.

The identifying pattern can be, among other things, for example, a simple single-sided printed circuit board or a pattern printed with conductive ink on the inside of the object base's bottom surface. As depicted in FIG. 20c to Appendix C, there is a central transmitting area 119-1. The identifying pattern is further comprised of a plurality of pickup area pattern pieces 107-1-118-1. When the block 701 is placed in a receiving block station 3-7, the central transmitting area 119-1 aligns over analog pickup electrode 61-2-1 as depicted in FIG. 21a to Appendix C.

In the embodiment described herein, the number of pickup pattern pieces in the identifying pattern is equal to the number of drive electrodes in the sensing device base unit 1. It should be noted that in alternative embodiments of the present invention, the number of drive electrodes is a multiple of the number of pickup pattern pieces in the identifying pattern.

As shown in the exemplary identification pattern depicted in FIG. 20c to Appendix C, the identification pattern provides a plurality of electrically conducting areas (109-1, 114-1, and 116-1). As is explained in further detail below, the sensing device identifies the block 701 by identifying which of the pickup pattern pieces 107-1-118-1 are aligned over each of the twelve (12) drive electrodes in the case of the four-sided embodiment depicted in FIGS. 20a, 20c, and 21a to Appendix C. The pattern of conductive and nonconductive areas of the object identification pattern layer corresponds to a unique bit pattern.

The microprocessor 1 rotates through the identifying pattern bit by bit until it identifies the bit pattern key. In such an embodiment, it is necessary to select the proper values for “N” (the number of drive electrodes which is also equal to the number of pickup area pattern pieces in the identifying pattern) and “K” (the number of connections between the pickup areas and the common transmitting area 119) so that there is a unique pattern for each object in the object set to be sensed such that none of the patterns selected can be misidentified as one of the other patterns in the object set as the microprocessor 1 rotates through the identifying pattern. The patterns so selected are referred to herein as “non-conflicting” keys, or patterns. In selecting the values for “N” and “K” for an embodiment that does not use a start of key bit pattern, certain rules are useful in developing the appropriate keys: 1) each pattern must be unique with respect to all other patterns for all possible rotations of the object 104 in the block station 102; 2) No key/pattern contains consecutive “1's”—that is, there must be at least one “0” between each “1”; and 3) there must be the same number of “1's” in each pattern so that the capacitance of the sensing plate is the same for all objects.

C. Capacitive Coupling.

FIG. 11 to Appendix C depicts an electrically conductive identifying pattern in the base 105 of an object 104 in close essentially horizontal proximity to a sensing drive electrode/pickup electrode array located under the floor surface 103 (3a-7a) of a block station 102 (3-7) of the base unit 1. The depicted orientation is properly aligned to allow capacitive coupling in that a particular drive electrode, e.g., 2, when fired with a drive signal will capacitively induce a charge in the pickup area 107 of the electrically conductive material in the identification pattern contained in the base 105 of object 104 such that the electrically conductive identifying pattern will conduct the induced charge to the common transmitting area 119 which will in turn induce a charge in the pickup electrode 61 (depicted as two sub-components 61-1 and 61-2).

FIG. 12 to Appendix C depicts another view of the object 104 to be identified with the base 105 in close essentially horizontal proximity to the sensing device feature of the present invention. FIG. 12 to Appendix C depicts the path of a charge resulting in the capacitive coupling of the sensing device with the object 104 to be identified.

As depicted in FIG. 12 to Appendix C, the microprocessor 1 generates a drive signal to a drive electrode, e.g., 2. The drive signal is transmitted from the microprocessor 1 through the input 39 to the shift register 35 and then through the output 43 of the shift register 35 to the drive electrode 2. If a conductive pickup area, e.g., 107, is aligned over the drive electrode 2, then the drive electrode 2 will induce a charge 81 over the gap between the drive electrode 2 and the conductive pickup area 2.

It should be noted that the term “aligned” as used herein does not require exact and complete alignment of the entire pickup area of the identifying pattern over the entire surface area of the electrode. Partial alignment is sufficient to allow the inducement of a charge from the drive electrode to a pickup area. The “range” recognized as a “1” as previously described above accounts for partial and full alignment.

The charge induced in the pickup area 107 is then transmitted 82 to the common transmitting area 119. The common transmitting area 119 will in turn induce a charge 83 over the gap between the common transmitting area 119 and the analog pickup electrode 61 in the block station well. The analog pickup electrode 61 will transmit the picked up pulse to the analog digital converter 62.

As depicted in FIG. 12 to Appendix C, each time that the microprocessor 1 sends a drive signal to one of the drive electrodes, e.g., 2, the microprocessor 1 instructs 66 the analog to digital converter 62 as depicted in FIG. 12 to Appendix C, to measure a pulse. As each drive electrode is fired with a drive signal from the microprocessor 1, if the drive electrode, e.g., 2, is aligned under a conductive pickup area, e.g., 107, of an object 104, then the portion of the pickup area and the common transmitting area 119 of the electrically conductive identifying pattern becomes capacitively coupled with the drive electrode/pickup electrode planar array.

The phrases “capacitively coupled” and “capacitive coupling” mean the inducement of a charge by a drive electrode to a receiving conductive area, either over a gap of free space or through one or more layers of electrically nonconductive dielectric material, such that the charge is then conducted to a transmitting area that subsequently induces a charge to a pickup electrode, over a different area of the same gap of free space or one or more layers of electrically nonconductive dielectric material.

As depicted in FIG. 12 to Appendix C, the pickup electrode 61 picks up a pulse from the top surface of the pickup electrode 61-2 and 61-1a, and conducts the charge to the underneath end of the electrically conductive cylinder 61-1b which is connected 69 to a set of operational amplifiers 63-65 which are in turn connected 67 to an analog to digital converter 62 which is connected to communicate 68 or otherwise communicates 68 the measured pulse with the microprocessor 1.

Because, as was previously described above, the microprocessor 1 instructs the analog to digital converter 62 to measure an incoming pulse at a certain time after the microprocessor 1 sends a drive signal to a drive electrode, e.g., 2, the analog to digital converter 62 will in turn measure the pulse and communicate the pulse in digital form to the microprocessor 1. In some embodiments of the present invention, the analog to digital converter 62 is part of, and included in, the microprocessor 1. Such is the case in the embodiment depicted, for instance, in FIG. 2 to Appendix C.

As depicted in FIG. 12 to Appendix C, the embodiments of the invention described herein sandwich the drive electrodes, e.g., 2, between a shielding ground plane layer 85 and a surface layer of dielectric material 84. As is also depicted in FIG. 12 to Appendix C, the embodiments of the invention described herein provide the identifying pattern, e.g., pickup area 107 and common transmitting area 119, as a layer of electrically conductive material inside the bottom surface of the base 105 of the object 104. It should be understood by one of ordinary skill in the art that in alternative embodiments, capacitive coupling is provided if either or both the drive electrode/pickup electrode array and the identifying electrically conductive pattern are exposed to air, liquid, gel, or other materials. The microprocessor 1 knows the location of each drive electrode 2-33, or in the case of the four-sided embodiment depicted in FIGS. 20a, 20c, and 21a to Appendix C electrodes 2-13, and generates a drive signal to each of the drive electrodes in serial fashion over a complete sensing cycle.

Once the microprocessor 1 has assembled a raw bit pattern, the microprocessor interprets the bit pattern as a key into a lookup table 87 as shown in FIG. 12 to Appendix C. In the exemplary embodiment described herein, the object 104 is a block with a letter. The microprocessor 1 interprets the bit pattern and then locates the identifier of the object 104 in the lookup table 87.

As depicted in FIG. 12 to Appendix C, the microprocessor 1 provides the digital sound representation identifier to audio circuitry 88 for delivery to speakers 89 contained in the exemplary toy embodiment. FIG. 18 depicts an exemplary embodiment of such audio circuitry.

D. Analyzing the Identifying Pattern.

As disclosed in U.S. Provisional Patent Application Ser. No. 60/165985, the disclosure of which has previously been incorporated here by reference as if fully stated here for all purposes, the microprocessor 1 is programmed to measure each induced charge picked up by the pickup electrode 61 and to assemble a set of the measured charges into a bit pattern for each sensing cycle. The magnitude of the signal at the output of the analog circuitry in response to the stimulus signal is proportional to the area of the stimulus electrode, the area of the pickup electrode, and the spacing between them. While an object, e.g., 104, with a base e.g., 105, containing an identifying pattern, e.g. as depicted in FIG. 20c to Appendix C, is resting in floor 3a-7a of a block station 3-7, as the microprocessor 1 shifts the stimulus around the array of electrodes 2-33, the pickup electrode 61 picks up pulses and communicates the pulses through a set of operational amplifiers 63-65 to the analog to digital converter 62 for communication to the microprocessor 1.

Once the microprocessor 1 has assembled a raw bit pattern, the microprocessor 1 interprets the bit pattern as a key into a lookup table 87 as shown in FIG. 12 to Appendix C.

Illustrative Embodiments

Although this invention has been described in certain specific embodiments, many additional modifications and variations would be apparent to those skilled in the art. It is, therefore, to be understood that this invention may be practiced otherwise than as specifically described. Thus, the embodiments of the invention described herein should be considered in all respects as illustrative and not restrictive, the scope of the invention to be determined by the appended claims and their equivalents rather than the foregoing description.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer system programmed for electronically teaching phonics, said computer system programmed to:
identify an alphabetic character for each block resting at a particular time in each of a plurality of block stations; and
determine a phoneme for each identified alphabetic character.

2. The computer system of claim 1 further programmed to determine each of said phonemes according to a set of phonics rules and according to the alphabetic characters identified for each block resting in the block stations at a particular time.

3. The computer system of claim 1 further programmed to:
form a word search key comprised of said identified alphabetic characters; and
retrieve an entry for said word search key from a dictionary of words.

4. The computer system of claim 3 wherein each block resting in a block station has a face resting in close, approximately horizontal proximity to a floor surface of said block station and wherein each resting block face rests at a first distance from a sensing device underneath said floor surface of said block station, said computer system further programmed to:
identify as a pressed block a block for which the resting block face of said block rests at a second distance from the sensing device wherein said second distance is less than said first distance;
use as a phoneme search key a phoneme instruction provided by said dictionary entry wherein said phoneme instruction positionally corresponds to a relative position of the identified alphabetic character a virtual word consisting of the identified alphabetic characters for the blocks resting in the block stations;
locate an entry in a phoneme table for said phoneme search key; and
deliver as an audible sound a phoneme representation from said phoneme entry in the phoneme table.

5. The computer system of claim 1 further programmed to:
compare each identified alphabetic character to the alphabetic characters identified for each block resting in the block stations at a particular time;
identify a set of phonetic relationships between the identified alphabetic character;
analyze each of said phonetic relationships according to a set of phonics rules; and
determine for each identified alphabetic character a phoneme according to said phonetic relationships.

6. The computer system of claim 5 wherein each block resting in a block station has a face resting in close, approximately horizontal proximity to a floor surface of said block station and wherein each resting block face rests at a first distance from a sensing device underneath said floor surface of said block station, said computer system further programmed to:
identify as a pressed block a block for which the resting block face of said block rests at a second distance from the sensing device wherein said second distance is less than said first distance; and
deliver as an audible sound the phoneme for the alphabetic character identified for said pressed block.

7. The computer system of claim 6 further programmed to:
identify a first block station containing a block; and
overlay a first digit of a binary template to coincide with the first block station containing a block.

8. The computer system of claim 7, wherein a lighting feature is associated with each block station, said computer system further programmed to:
instruct the lighting feature associated with said block station containing said pressed block to light; and
instruct each lighting feature associated with each block station containing a block identified as phonetically related to said pressed block to light.

9. The computer system of claim 1 wherein in order to identify an alphabetic character for a block resting at a particular time in a block station, the computer system is further programmed to:
serially generate a plurality of digital drive signals to a plurality of drive electrodes configured in a planar array, said drive electrodes being exposed for capacitive coupling with a conductive layer;
serially charge each of said drive electrodes with said drive signal to capacitively induce by each of said charged drive electrodes a charge in a plane comprising a pattern of electrically conductive material and nonconductive material, said pattern being configured to have a plurality of pickup areas, a plurality of nonconducting areas, and a common transmitting area, wherein said pattern corresponds to a unique bit pattern, wherein each of said pickup areas conducts said induced charge to said transmitting area, and wherein said transmitting area induces a charge in a set of at least one pickup electrode configured in an area of said planar array;
interpret as a bit pattern changes in induced charges picked up by said set of pickup electrodes;
use said bit pattern as a key to a lookup table, said lookup table being comprised of a plurality of keys, each key corresponding to an alphabetic character identifier; and
retrieve from said lookup table said corresponding alphabetic character identifier.

10. A computer program product for electronically teaching phonics, said computer program product having instructions for:
identifying an alphabetic character for each block resting at a particular time in each of a plurality of block stations; and
determining a phoneme for each identified alphabetic character.

11. The computer program product of claim 10 having further instructions for:
determining each of said phonemes according to a set of phonics rules and according to the alphabetic characters identified for each block resting in the block stations at a particular time.

12. The computer program product of claim 10 having further instructions for:
forming a word search key comprised of said identified alphabetic characters; and
retrieving an entry for said word search key from a dictionary of words.

13. The computer program product of claim 12 wherein each block resting in a block station has a face resting in close, approximately horizontal proximity to a floor surface of said block station and wherein each resting block face rests at a first distance from a sensing device underneath said floor surface of said block station, said computer program product having further instructions for:
identifying as a pressed block a block for which the resting block face of said block rests at a second distance from the sensing device wherein said second distance is less than said first distance;
using as a phoneme search key a phoneme instruction provided by said dictionary entry wherein said phoneme instruction positionally corresponds to a relative position of the identified alphabetic character a virtual word consisting of the identified alphabetic characters for the blocks resting in the block stations;
locating an entry in a phoneme table for said phoneme search key; and
delivering as an audible sound a phoneme representation from said phoneme entry in the phoneme table.

14. The computer program product of claim 10 having further programming instructions for:
comparing each identified alphabetic character to the alphabetic characters identified for each block resting in the block stations at a particular time;
identifying a set of phonetic relationships between the identified alphabetic character;
analyzing each of said phonetic relationships according to a set of phonics rules; and
determining for each identified alphabetic character a phoneme according to said phonetic relationships.

15. The computer program product of claim 14 wherein each block resting in a block station has a face resting in close, approximately horizontal proximity to a floor surface of said block station and wherein each resting block face rests at a first distance from a sensing device underneath said floor surface of said block station, said computer program product having further instructions for:
identifying as a pressed block a block for which the resting block face of said block rests at a second distance from the sensing device wherein said second distance is less than said first distance; and
delivering as an audible sound the phoneme for the alphabetic character identified for said pressed block.

16. The computer program product of claim 15 having further programming instructions for:
identifying a first block station containing a block; and
overlaying a first digit of a binary template to coincide with the first block station containing a block.

17. The computer program product of claim 16, wherein a lighting feature is associated with each block station, said computer program product having further programming instructions for:
instructing the lighting feature associated with said block station containing said pressed block to light; and
instructing each lighting feature associated with each block station containing a block identified as phonetically related to said pressed block to light.

18. The computer program product of claim 10 wherein in order to identify an alphabetic character for a block resting at a particular time in a block station, said computer program product has further programming instructions for:
serially generating a plurality of digital drive signals to a plurality of drive electrodes configured in a planar array, said drive electrodes being exposed for capacitive coupling with a conductive layer;
serially charging each of said drive electrodes with said drive signal to capacitively induce by each of said charged drive electrodes a charge in a plane comprising a pattern of electrically conductive material and nonconductive material, said pattern being configured to have a plurality of pickup areas, a plurality of nonconducting areas, and a common transmitting area, wherein said pattern corresponds to a unique bit pattern, wherein each of said pickup areas conducts said induced charge to said transmitting area, and wherein said transmitting area induces a charge in a set of at least one pickup electrode configured in an area of said planar array;
interpreting as a bit pattern changes in induced charges picked up by said set of pickup electrodes;
using said bit pattern as a key to a lookup table, said lookup table being comprised of a plurality of keys, each key corresponding to an alphabetic character identifier; and
retrieving from said lookup table said corresponding alphabetic character identifier.

19. A method using a computer for electronically teaching phonics, said method comprising:
identifying an alphabetic character for each block resting at a particular time in each of a plurality of block stations; and
determining a phoneme for each identified alphabetic character.

20. The method of claim 19 further comprising determining each of said phonemes according to a set of phonics rules and according to the alphabetic characters identified for each block resting in the block stations at a particular time.

21. The method of claim 19 further comprising:
forming a word search key comprised of said identified alphabetic characters; and
retrieving an entry for said word search key from a dictionary of words.

22. The method of claim 21 wherein each block resting in a block station has a face resting in close, approximately horizontal proximity to a floor surface of said block station and wherein each resting block face rests at a first distance from a sensing device underneath said floor surface of said block station, said method further comprising:
identifying as a pressed block a block for which the resting block face of said block rests at a second distance from the sensing device wherein said second distance is less than said first distance;
using as a phoneme search key a phoneme instruction provided by said dictionary entry wherein said phoneme instruction positionally corresponds to a relative position of the identified alphabetic character a virtual word consisting of the identified alphabetic characters for the blocks resting in the block stations;
locating an entry in a phoneme table for said phoneme search key; and
delivering as an audible sound a phoneme representation from said phoneme entry in the phoneme table.

23. The method of claim 19 further comprising:
comparing each identified alphabetic character to the alphabetic characters identified for each block resting in the block stations at a particular time;
identifying a set of phonetic relationships between the identified alphabetic character;
analyzing each of said phonetic relationships according to a set of phonics rules; and
determining for each identified alphabetic character a phoneme according to said phonetic relationships.

24. The method of claim 23 wherein each block resting in a block station has a face resting in close, approximately horizontal proximity to a floor surface of said block station and wherein each resting block face rests at a first distance from a sensing device underneath said floor surface of said block station, said method further comprising:
identifying as a pressed block a block for which the resting block face of said block rests at a second distance from the sensing device wherein said second distance is less than said first distance; and
delivering as an audible sound the phoneme for the alphabetic character identified for said pressed block.

25. The method of claim 24 further comprising:
identifying a first block station containing a block; and
overlaying a first digit of a binary template to coincide with the first block station containing a block.

26. The method of claim 25, wherein a lighting feature is associated with each block station, said method further comprising:
instructing the lighting feature associated with said block station containing said pressed block to light; and
instructing each lighting feature associated with each block station containing a block identified as phonetically related to said pressed block to light.

27. The method of claim 19 wherein in order to identify an alphabetic character for a block resting at a particular time in a block station, said method further comprising:
serially generating a plurality of digital drive signals to a plurality of drive electrodes configured in a planar array, said drive electrodes being exposed for capacitive coupling with a conductive layer;
serially charging each of said drive electrodes with said drive signal to capacitively induce by each of said charged drive electrodes a charge in a plane comprising a pattern of electrically conductive material and nonconductive material, said pattern being configured to have a plurality of pickup areas, a plurality of nonconducting areas, and a common transmitting area, wherein said pattern corresponds to a unique bit pattern, wherein each of said pickup areas conducts said induced charge to said transmitting area, and wherein said transmitting area induces a charge in a set of at least one pickup electrode configured in an area of said planar array;
interpreting as a bit pattern changes in induced charges picked up by said set of pickup electrodes;
using said bit pattern as a key to a lookup table, said lookup table being comprised of a plurality of keys, each key corresponding to an alphabetic character identifier; and retrieving from said lookup table said corresponding alphabetic character identifier.

28. A computer phonics teaching system for electronically teaching phonics, said system comprising:
program instructions for identifying an alphabetic character for each block resting at a particular time in each of a plurality of block stations; and
program instructions for determining a phoneme for each identified alphabetic character.

29. The computer phonics teaching system of claim 28, said system further comprising:
program instructions for determining each of said phonemes according to a set of phonics rules and according to the alphabetic characters identified for each block resting in the block stations at a particular time.

30. The computer phonics teaching system of claim 28, said system further comprising:
program instructions for forming a word search key comprised of said identified alphabetic characters; and
program instructions for retrieving an entry for said word search key from a dictionary of words.

31. The computer phonics teaching system of claim 30 wherein each block resting in a block station has a face resting in close, approximately horizontal proximity to a floor surface of said block station and wherein each resting block face rests at a first distance from a sensing device underneath said floor surface of said block station, said system further comprising:
program instructions for identifying as a pressed block a block for which the resting block face of said block rests at a second distance from the sensing device wherein said second distance is less than said first distance;
program instructions for using as a phoneme search key a phoneme instruction provided by said dictionary entry wherein said phoneme instruction positionally corresponds to a relative position of the identified alphabetic character a virtual word consisting of the identified alphabetic characters for the blocks resting in the block stations;
program instructions for locating an entry in a phoneme table for said phoneme search key; and
program instructions for delivering as an audible sound a phoneme representation from said phoneme entry in the phoneme table.

32. The computer phonics teaching system of claim 28, said system further comprising:
program instructions for comparing each identified alphabetic character to the alphabetic characters identified for each block resting in the block stations at a particular time;
program instructions for identifying a set of phonetic relationships between the identified alphabetic character;
program instructions for analyzing each of said phonetic relationships according to a set of phonics rules; and
program instructions for determining for each identified alphabetic character a phoneme according to said phonetic relationships.

33. The computer phonics teaching system of claim 32 wherein each block resting in a block station has a face resting in close, approximately horizontal proximity to a floor surface of said block station and wherein each resting block face rests at a first distance from a sensing device underneath said floor surface of said block station, said system further comprising:
program instructions for identifying as a pressed block a block for which the resting block face of said block rests at a second distance from the sensing device wherein said second distance is less than said first distance; and
program instructions for delivering as an audible sound the phoneme for the alphabetic character identified for said pressed block.

34. The computer phonics teaching system of claim 33, said system further comprising:
program instructions for identifying a first block station containing a block; and
program instructions for overlaying a first digit of a binary template to coincide with the first block station containing a block.

35. The computer phonics teaching system of claim 34, wherein a lighting feature is associated with each block station, said system further comprising:
program instructions for instructing the lighting feature associated with said block station containing said pressed block to light; and
program instructions for instructing each lighting feature associated with each block station containing a block identified as phonetically related to said pressed block to light.

36. The computer phonics teaching system of claim 28 wherein in order to identify an alphabetic character for a block resting at a particular time in a block station, said system further comprising:
program instructions for serially generating a plurality of digital drive signals to a plurality of drive electrodes configured in a planar array, said drive electrodes being exposed for capacitive coupling with a conductive layer;
program instructions for serially charging each of said drive electrodes with said drive signal to capacitively induce by each of said charged drive electrodes a charge in a plane comprising a pattern of electrically conductive material and nonconductive material, said pattern being configured to have a plurality of pickup areas, a plurality of nonconducting areas, and a common transmitting area, wherein said pattern corresponds to a unique bit pattern, wherein each of said pickup areas conducts said induced charge to said transmitting area, and wherein said transmitting area induces a charge in a set of at least one pickup electrode configured in an area of said planar array;
program instructions for interpreting as a bit pattern changes in induced charges picked up by said set of pickup electrodes;
program instructions for using said bit pattern as a key to a lookup table, said lookup table being comprised of a plurality of keys, each key corresponding to an alphabetic character identifier; and
program instructions for retrieving from said lookup table said corresponding alphabetic character identifier.

37. A device for electronically teaching phonics, said device comprising:
a base unit providing a plurality of block stations, each block station for receiving a block, each block station having a floor surface, said floor surface recessed from the top surface of the base unit, said floor surface having a plurality of upward projections, each projection having a first length;
a sensing device underneath the floor surface of each block station;
a plurality of blocks, each block having six faces, each block face featuring an alphabetic character, each block face having an inner surface comprising a pattern of electrically conductive material and nonconductive material configured in a plane wherein said pattern corresponds to a bit pattern that identifies the alphabetic character featured on the outer surface of the opposing face of the block;
a computer device configured to communicate with each of said sensing devices;
said computer device programmed to identify the alphabetic character featured on each block resting at a particular time in each of said block stations according to information provided by each of said sensing devices; and
said computer device further programmed to determine a phoneme for each identified alphabetic character.

38. A method of electronically teaching phonics to a player, comprising:
determining an alphabetic sequence from lettered objects arranged by the player;
generating a phoneme sequence according to the alphabetic sequence; and
generating an audio signal for the player according to the phoneme sequence.

39. The method of claim 38, wherein generating the phoneme sequence includes:
matching the alphabetic sequence with a word stored in a word dictionary;
reading a phoneme key sequence associated with the word in the word dictionary; and
generating the phoneme sequence from the phoneme key sequence.

40. The method of claim 38, wherein generating the phoneme sequence includes analyzing the alphabetic sequence using a set of phonics rules.

41. The method of claim 38, wherein generating the phoneme sequence includes:
determining that the alphabetic sequence does not match a word stored in a word dictionary; and
generating the phoneme sequence by analyzing the alphabetic sequence using a set of phonics rules.

42. A method of electronically teaching phonics to a player, comprising:
determining an alphabetic sequence from lettered objects arranged by the player;
receiving a selection signal corresponding to a selected element of the alphabetic sequence;
generating a phoneme for the selected element of the alphabetic sequence; and
generating an audio signal according to the phoneme.

43. The method of claim 42, wherein generating the phoneme includes:
matching the alphabetic sequence with a word stored in a word dictionary;
reading a phoneme key for the selected element of the alphabetic sequence associated with the word in the word dictionary; and
generating the phoneme from the phoneme key.

44. The method of claim 43, further comprising:
reading visual display instructions associated with the word in the word dictionary; and
generating visual display signals according to the visual display instructions.

45. The method of claim 43, wherein generating the phoneme includes:
determining that the alphabetic sequence does not match a word stored in a word dictionary; and
generating the phoneme by analyzing the alphabetic sequence using a set of phonics rules.

46. The method of claim 45, further comprising:
generating visual display instructions by analyzing the alphabetic sequence using a set of phonics rules; and
generating visual display signals according to the visual display instructions.

47. A method of electronically teaching phonics to a player using a plurality of lettered objects, comprising:
providing a plurality of stations;
determining an alphabetic sequence from lettered objects placed by the player in the plurality of stations;
matching the alphabetic sequence with a word stored in a word dictionary;
reading a phoneme key sequence associated with the word in the word dictionary;
generating the phoneme sequence from the phoneme key sequence;
generating an audio signal according to the phoneme sequence;
reading visual display instructions associated with the word in the word dictionary; and
lighting one of a plurality of lighting features associated with the plurality of stations using the visual display instructions.

48. The method of claim 47 wherein the lettered objects are blocks.

49. The method of claim 47 wherein the lettered objects are tiles.

50. A method of electronically teaching phonics to a player using a plurality of lettered objects, comprising:
providing a plurality of stations;
determining an alphabetic sequence from lettered objects placed by the player in the plurality of stations;
generating the phoneme by analyzing the alphabetic sequence using a set of phonics rules;
generating an audio signal according to the phoneme sequence;
generating visual display instructions by analyzing the alphabetic sequence using a set of phonics rules; and
lighting one of a plurality of lighting features associated with the plurality of stations using the visual display instructions.

51. The method of claim 50 wherein the lettered objects are blocks.

52. The method of claim 50 wherein the lettered objects are tiles.

53. An apparatus for teaching phonics to a player, comprising:
a processor; and
a memory operably coupled to the processor and having program instructions stored therein, the processor being operable to execute the program instructions, the program instructions including:
determining an alphabetic sequence from lettered objects arranged by the player;
generating a phoneme sequence according to the alphabetic sequence; and
generating an audio signal for the player according to the phoneme sequence.

54. The apparatus of claim 53, wherein the program instructions for generating the phoneme sequence include:
matching the alphabetic sequence with a word stored in a word dictionary;
reading a phoneme key sequence associated with the word in the word dictionary; and
generating the phoneme sequence from the phoneme key sequence.

55. The apparatus of claim 53, wherein the program instructions for generating the phoneme sequence include analyzing the alphabetic sequence using a set of phonics rules.

56. The apparatus of claim 53, wherein the program instructions for generating the phoneme sequence include:
determining that the alphabetic sequence does not match a word stored in a word dictionary; and
generating the phoneme sequence by analyzing the alphabetic sequence using a set of phonics rules.

57. An apparatus for teaching phonics to a player, comprising:
a processor; and
a memory operably coupled to the processor and having program instructions stored therein, the processor being operable to execute the program instructions, the program instructions including:
determining an alphabetic sequence from lettered objects arranged by the player;
receiving a selection signal corresponding to a selected element of the alphabetic sequence;
generating a phoneme for the selected element of the alphabetic sequence; and
generating an audio signal according to the phoneme.

58. The apparatus of claim 57, wherein the program instructions for generating the phoneme include:
matching the alphabetic sequence with a word stored in a word dictionary;
reading a phoneme key for the selected element of the alphabetic sequence associated with the word in the word dictionary; and
generating the phoneme from the phoneme key.

59. The apparatus of claim 58, the program instructions further including:
reading visual display instructions associated with the word in the word dictionary; and
generating visual display signals according to the visual display instructions.

60. The apparatus of claim 57, wherein the program instructions for generating the phoneme include:
determining that the alphabetic sequence does not match a word stored in a word dictionary; and
generating the phoneme by analyzing the alphabetic sequence using a set of phonics rules.

61. The apparatus of claim 60, the program instructions further including:
generating visual display instructions by analyzing the alphabetic sequence using a set of phonics rules; and
generating visual display signals according to the visual display instructions.

62. An apparatus for teaching phonics to a player, comprising:
a processor;
a plurality object sensing stations;
a memory operably coupled to the processor and having program instructions stored therein, the processor being operable to execute the program instructions, the program instructions including:
determining an alphabetic sequence from lettered objects placed by the player in the plurality of object sensing stations;
matching the alphabetic sequence with a word stored in a word dictionary;
reading a phoneme key sequence associated with the word in the word dictionary;
generating the phoneme sequence from the phoneme key sequence;
generating an audio signal according to the phoneme sequence;
reading visual display instructions associated with the word in the word dictionary; and
lighting one of a plurality of lighting features associated with the plurality of stations using the visual display instructions.

63. The apparatus of claim 62 wherein the lettered objects are blocks.

64. The apparatus of claim 62 wherein the lettered objects are tiles.

65. An apparatus for teaching phonics to a player, comprising:
a processor;
a plurality object sensing stations;
a memory operably coupled to the processor and having program instructions stored therein, the processor being operable to execute the program instructions, the program instructions including:
determining an alphabetic sequence from lettered objects placed by the player in the plurality of stations;
generating the phoneme by analyzing the alphabetic sequence using a set of phonics rules;
generating an audio signal according to the phoneme sequence;
generating visual display instructions by analyzing the alphabetic sequence using a set of phonics rules; and
lighting one of a plurality of lighting features associated with the plurality of stations using the visual display instructions.

66. The apparatus of claim 65 wherein the lettered objects are blocks.

67. The apparatus of claim 65 wherein the lettered objects are tiles.

68. A processor-readable storage medium embodying processor program instructions for execution by a processor, the processor program instructions adapting a processor to teach phonics to a player, the processor program instructions including:
determining an alphabetic sequence from lettered objects arranged by the player;
generating a phoneme sequence according to the alphabetic sequence; and
generating an audio signal for the player according to the phoneme sequence.

69. The processor-readable storage medium of claim 68, wherein the process program instructions for generating the phoneme sequence include:
matching the alphabetic sequence with a word stored in a word dictionary;
reading a phoneme key sequence associated with the word in the word dictionary; and
generating the phoneme sequence from the phoneme key sequence.

70. The processor-readable storage medium of claim 68, wherein the processor program instructions for generating the phoneme sequence include analyzing the alphabetic sequence using a set of phonics rules.

71. The processor-readable storage medium of claim 68, wherein the processor program instructions for generating the phoneme sequence include:
determining that the alphabetic sequence does not match a word stored in a word dictionary; and
generating the phoneme sequence by analyzing the alphabetic sequence using a set of phonics rules.

72. A processor-readable storage medium embodying processor program instructions for execution by a processor, the processor program instructions adapting a processor to teach phonics to a player, the processor program instructions including:
determining an alphabetic sequence from lettered objects arranged by the player;
receiving a selection signal corresponding to a selected element of the alphabetic sequence;
generating a phoneme for the selected element of the alphabetic sequence; and
generating an audio signal according to the phoneme.

73. The processor-readable storage medium of claim 72, wherein the processor program instructions for generating the phoneme include:
matching the alphabetic sequence with a word stored in a word dictionary;
reading a phoneme key for the selected element of the alphabetic sequence associated with the word in the word dictionary; and
generating the phoneme from the phoneme key.

74. The processor-readable storage medium of claim 73, the processor program instructions further including:
reading visual display instructions associated with the word in the word dictionary; and
generating visual display signals according to the visual display instructions.

75. The processor-readable storage medium of claim 72, wherein the processor program instructions for generating the phoneme include:
determining that the alphabetic sequence does not match a word stored in a word dictionary; and
generating the phoneme by analyzing the alphabetic sequence using a set of phonics rules.

76. The processor-readable storage medium of claim 75, the processor program instructions further including:
generating visual display instructions by analyzing the alphabetic sequence using a set of phonics rules; and
generating visual display signals according to the visual display instructions.

77. A processor-readable storage medium embodying processor program instructions for execution by a processor, the processor program instructions adapting a processor to teach phonics to a player, the processor program instructions including:
determining an alphabetic sequence from lettered objects placed by the player in a pluarlity of object sensing stations;
matching the alphabetic sequence with a word stored in a word dictionary;
reading a phoneme key sequence associated with the word in the word dictionary;
generating the phoneme sequence from the phoneme key sequence;
generating an audio signal according to the phoneme sequence;
reading visual display instructions associated with the word in the word dictionary; and
lighting one of a plurality of lighting features associated with the plurality of stations using the visual display instructions.

78. A processor-readable storage medium embodying processor program instructions for execution by a processor, the processor program instructions adapting a processor to teach phonics to a player, the processor program instructions including:
determining an alphabetic sequence from lettered objects placed by the player in the pluarlity of stations;
generating the phoneme by analyzing the alphabetic sequence using a set of phonics rules;
generating an audio signal according to the phoneme sequence;
generating visual display instructions by analyzing the alphabetic sequence using a set of phonics rules; and
lighting one of a plurality of lighting features associated with the plurality of stations using the visual display instructions.
